(19) United States
(12) Patent Application Publication
(10) Pub. No.: US 2010/0211380 A1
(43) Pub. Date: Aug. 19, 2010

(54) INFORMATION PROCESSING APPARATUS AND INFORMATION PROCESSING METHOD, AND PROGRAM

(75) Inventor: Yukiko KANEKIYO, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/688,216

(22) Filed: Jan. 15, 2010

(30) Foreign Application Priority Data
Feb. 18, 2009 (JP) 2009-035130

(51) Int. Cl. G06F 17/27

(52) U.S. Cl. 704/9

(57) ABSTRACT

An information processing apparatus includes: an acquiring unit acquiring text data as data associated with plural contents; a separating unit separating the text data acquired by the acquiring means into words of a predetermined unit in accordance with attributes; a comparing unit calculating a correspondence length indicating the number of words which continuously correspond to each other in order of the attributes between the text data, by comparing the words, which are separated by the separating means, between the text data of the plural contents; a calculating unit calculating a similarity degree score indicating a similarity degree between the contents corresponding to the text data on the basis of the correspondence length obtained by the comparing means; and a display controlling unit controlling displaying outlines of the plural contents on the basis of the similarity degree score between a predetermined content and another content among the plural contents.

### BACKGROUND OF THE INVENTION

1. Field of the Invention

The present invention relates to an information processing apparatus, an information processing method, and a program, and in particular, to an information processing apparatus, an information processing method, and a program capable of determining programs having the same contents among recorded programs more efficiently and more exactly and to arrange the recorded programs efficiently by a user.

2. Description of the Related Art

Various techniques were suggested to compare programs to each other.

For example, there was suggested a technique capable of comparing a reservation candidate program to a previously recorded program on the basis of EPG (Electronic Program Guide) information to prevent double recording when a recorded program is rerun (see Japanese Unexamined Patent Application Publication No. 2007-281752).

Moreover, there was suggested a technique capable of comparing program titles included in the EPG information to each other in accordance with characters (in particular, Japanese characters) to determine the same program (see Japanese Unexamined Patent Application Publication No. 2007-102489).

Furthermore, there was suggested a technique capable of extracting the same program by calculating similarities from an agreement ratio of keywords included in program information (see Japanese Unexamined Patent Application Publication No. 2007-74169).

In the above-mentioned techniques, however, recorded programs having the same contents may not be distinguished efficiently and exactly so as to be easily understandable to a user. Specifically, when the user dubs programs recorded in an HDD (Hard Disk Drive) to a record media or the like, for example, the user may not arrange the recorded programs and particularly delete the repeatedly recorded programs effectively.

In Japanese Unexamined Patent Application Publication No. 2007-281752, the reservation candidate programs and the previously recorded programs are compared to each other using only three kinds of information, that is, “a program title”, “broadcast time information”, and “a rerun flag” included in the EPG information. Therefore, the precision of the comparison is restrictive and thus it is difficult to exactly distinguish programs having the same contents.

In Japanese Unexamined Patent Application Publication No. 2007-281752, even when programs having the same contents (at the same broadcast time) are recorded by rerun or simultaneous interpretation broadcast, the calculation amount increases as the number of the characters increases. Therefore it is difficult to distinguish whether or not these programs are the same program of which the broadcast time is the same by comparing only with the program titles.

In order to solve this problem, Japanese Unexamined Patent Application Publication No. 2007-102489 suggested the technique of comparing program summaries or program details included in the EPG information in accordance with the characters.

In the digital broadcast, the upper limit number of characters of a program title included in an EIT (Event Information Table) of PSI/SI (Program Specific Information/Service Information) serving as basic information of the EPG is 40 characters in a mixture of Chinese characters and Japanese characters. The upper limit number of characters of a program summary is 80 characters. There is no upper limit number in the program details. Here, when the program summaries or the program details of the EPG information are compared to each other in accordance with the characters by the technique disclosed in Japanese Unexamined Patent Application Publication No. 2007-102489, it is difficult to efficiently distinguish the programs having the same contents.

Here, when the program details included in the EPG information are compared to each other by the technique disclosed in Japanese Unexamined Patent Application Publication No. 2007-74169, the similarity degree between programs can be calculated by the agreement ratio of the keywords included in the program details.

In the technique disclosed in Japanese Unexamined Patent Application Publication No. 2007-74169, however, when the same programs broadcast at different broadcast times are compared to each other, there is a high possibility that the same keywords are contained in the respective program details. Therefore, even when the compared programs have the sane similarity degree, it is difficult to determine whether the compared programs are the program which has been rerun or broadcasted by simultaneous interpretation and have the same contents (the same broadcast time) or to determine whether the compared programs are the same program which has been broadcast at different broadcast times.

### SUMMARY OF THE INVENTION

It is desirable to determine programs having the same contents among recorded programs more efficiently and more exactly to arrange the recorded programs efficiently by a user.

An information processing apparatus according to an embodiment of the invention includes: acquiring means for acquiring text data as data associated with plural contents; separating means for separating the text data acquired by the acquiring means into words of a predetermined unit in accordance with attributes; comparing means for calculating a correspondence length indicating the number of words which continuously correspond to each other in order of the attributes between the text data, by comparing the words, which are separated by the separating means, between the text data of the plural contents; calculating means for calculating a similarity degree score indicating a similarity degree between the contents corresponding to the text data on the basis of the correspondence length obtained by the comparing means; and display controlling means for controlling displaying outlines of the plural contents on the basis of the similarity degree score, which is calculated by the calculating means, between a predetermined content and another content among the plural contents.

The calculating means may calculate the similarity degree score between the contents corresponding to the text data on the basis of the number of correspondence lengths depending on the sizes of the correspondence lengths and a weight corresponding to the correspondence lengths.

The weight may have a larger value as the size of the correspondence length is larger.

The separating means may separate the text data into morphemes by analyzing the morphemes of the text data acquired by the acquiring means. The comparing means may obtain the correspondence length indicating the number of morphemes which continuously correspond to each other between the text data in order of parts of speech of the morphemes by comparing the morphemes between the text data of the plural contents, the morphemes being separated by the separating means. In this case, the kinds of the parts of speech are treated as the attributes.

On the basis of a magnitude relation between the similarity degree score between the predetermined content and the another content and a predetermined threshold value, the display controlling means may control the displaying of another content in the outlines of the plural contents.

The display controlling means may control the displaying so as to emphasize the display of the another content, of which the similarity degree score with the predetermined content is larger than the predetermined threshold value, in the outlines of the plural contents.

The display controlling means may control the display so that the another content, of which the similarity degree score with the predetermined content is larger than the predetermined threshold value, is displayed in the outlines of the plural contents.

The information processing apparatus according to the embodiment of the invention may further include difference detecting means for detecting a difference between data, which are respectively associated with the predetermined content and the another content among the plural contents, other than the text data. The separating means may separate the text data of the predetermined content and the another content, of which the difference detected by the difference detecting means is smaller than a predetermined degree, into the words of the predetermined unit.

An information processing method according to an embodiment of the invention includes the steps of: acquiring text data as data associated with plural contents; separating the text data acquired by the acquiring step into words of a predetermined unit in accordance with attributes; calculating a correspondence length indicating the number of words which continuously correspond to each other in order of the attributes between the text data, by comparing the words, which are separated by the separating means, between the text data of the plural contents; calculating a similarity degree score indicating a similarity degree between the contents corresponding to the text data on the basis of the correspondence length obtained by the comparing step; and controlling displaying outlines of the plural contents on the basis of the similarity degree score, which is calculated by the calculating step, between a predetermined content and another content among the plural contents.

A program according to an embodiment of the invention causes a computer to execute: an acquiring step of acquiring text data as data associated with plural contents; a separating step of separating the text data acquired by the acquiring step into words of a predetermined unit in accordance with attributes; a comparing step of calculating a correspondence length indicating the number of words which continuously correspond to each other in order of the attributes between the text data, by comparing the words, which are separated by the separating means, between the text data of the plural contents; a calculating step of calculating a similarity degree score indicating a similarity degree between the contents corresponding to the text data on the basis of the correspondence length obtained by the comparing step; and a display controlling step of controlling displaying outlines of the plural contents on the basis of the similarity degree score, which is calculated by the calculating step, between a predetermined content and another content among the plural contents.

According to an embodiment of the invention, text data are acquired as data associated with plural contents; the acquired text data are separated into words of a predetermined unit in accordance with attributes; a correspondence length indicating the number of words which continuously correspond to each other in order of the attributes between the text data is calculated by comparing the separated words between the text data of the plural contents; a similarity degree score indicating a similarity degree between the contents corresponding to the text data is calculated on the basis of the obtained correspondence length; and displaying outlines of the plural contents is controlled on the basis of the calculated similarity degree score between a predetermined content and another content among the plural contents.

According to an embodiment of the invention, the programs having the same contents are distinguished from each other more efficiently and more exactly to show the programs to a user in a simple manner.

### BRIEF DESCRIPTION OF THE DRAWINGS

FIG. 1 is a block diagram illustrating an exemplary hardware configuration of an HDD recorder of an information processing apparatus according to an embodiment of the invention.

FIG. 2 is a block diagram illustrating an exemplary function configuration of the HDD recorder.

FIG. 3 is a flowchart illustrating a program outline display process of the HDD recorder.

FIG. 4 is a diagram illustrating a program outline displayed on a display unit of a television receiver.

FIG. 5 is a diagram illustrating an example of EPG data.

FIG. 6 is a flowchart illustrating a similarity degree calculating process in detail.

FIG. 7 is a diagram illustrating arrangement of parts of speech of morphemes.

FIG. 8 is a diagram illustrating an example of a correspondence series length.

FIG. 9 is a diagram illustrating an exemplary calculation of a similarity degree score.

FIG. 10 is a diagram illustrating an exemplary calculation of a total similarity ratio.

FIG. 11 is a diagram illustrating an exemplary display of a program outline.

FIG. 12 is a diagram illustrating another exemplary display of the correspondence series length.

FIG. 13 is a diagram illustrating still another exemplary display of the correspondence series length.

FIG. 14 is a diagram illustrating another exemplary display of the program outline.

FIG. 15 is a diagram illustrating still another exemplary display of the program outline.

FIG. 16 is a diagram illustrating still another exemplary display of the program outline.

FIG. 17 is a diagram illustrating still another exemplary display of the program outline.

FIG. 18 is a diagram illustrating still another exemplary display of the program outline.

FIG. 19 is a diagram illustrating still another exemplary display of the program outline.

FIG. 20 is a diagram illustrating an exemplary display of a program outline and a dubbing candidate outline.

FIG. 21 is a block diagram illustrating an exemplary function configuration of an HDD recorder according to a second embodiment.

FIG. 22 is a flowchart illustrating a program outline display process of the HDD recorder according to the second embodiment.

### DESCRIPTION OF THE PREFERRED EMBODIMENTS

Hereinafter, embodiments of the invention will be described with reference to the drawings in the following order.

### 1. First Embodiment

### 2. Second Embodiment

### 1. First Embodiment

### Exemplary Hardware Configuration of HDD Recorder

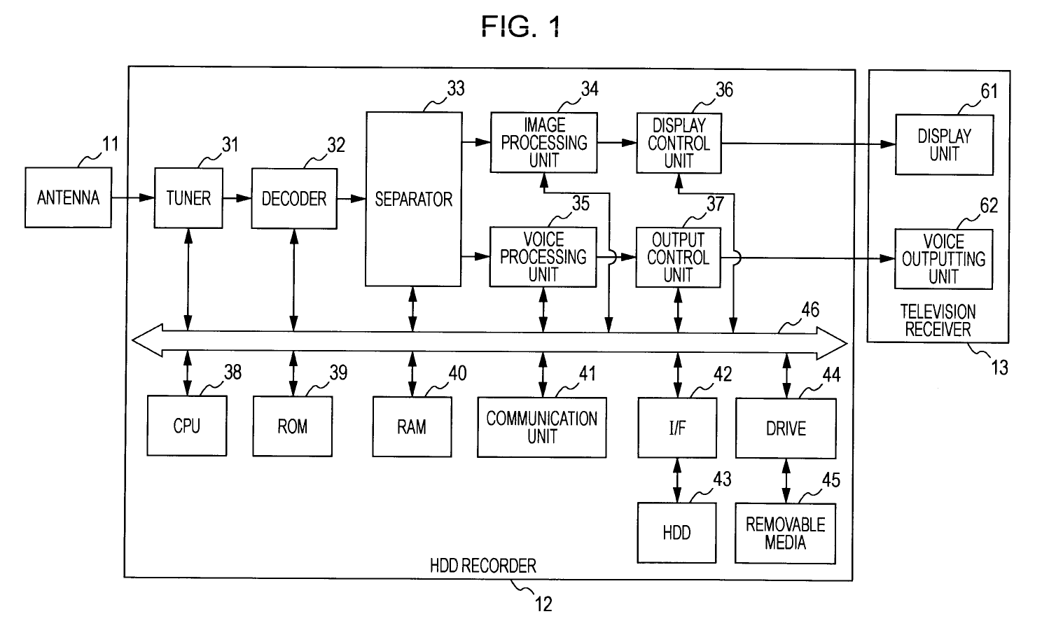

FIG. 1 is a diagram illustrating an exemplary hardware configuration of an HDD (Hard Disk Drive) recorder of an information processing apparatus according to an embodiment of the invention.

In FIG. 1, an antenna 11 receives a digital broadcast signal transmitted from a television broadcast station (not shown) and supplies the digital broadcast signal to an HDD recorder 12. The HDD recorder 12 records the digital broadcast signal supplied from the antenna 11. A television receiver 13 which is connected to the HDD recorder 12 displays an image in accordance with an image signal supplied from the HDD recorder 12 and outputs a voice in accordance with a voice signal supplied from the HDD recorder 12.

The HDD recorder 12 may be realized as an AV (Audio Visual) device or may be incorporated with the television receiver 13, for example. Alternatively, the incorporated device of the HDD recorder 12 and the television receiver 13 may be configured as an electronic apparatus such as a PC (Personal Computer), a PDA (Personal Digital Assistant), a portable phone having a function of acquiring broadcast waves (in effect, contents and metadata of the contents).

The HDD recorder 12 in FIG. 1 includes a tuner 31, a decoder 32, a separator 33, an image processing unit 34, a voice processing unit 35, a display control unit 36, an output control unit 37, a CPU (Central Processing Unit) 38, a ROM (Read-Only Memory) 39, a RAM (Random Access Memory) 40, a communication unit 41, an I/F (interface) 42, an HDD 43, a drive 44, a removable media 45, and a bus 46.

The tuner 31, the decoder 32, the separator 33, the image processing unit 34, the voice processing unit 35, the display control unit 36, the output control unit 37, the CPU (Central Processing Unit) 38, the ROM (Read-Only Memory) 39, the RAM (Random Access Memory) 40, the communication unit 41, and the I/F (interface) 42 are connected to each other through the bus 46. The bus 46 is connected to the drive 44, as necessary, and is mounted appropriately with the removable media 45 such as a magnetic disk, an optical disk, a magneto-optical disk, or a semiconductor memory. A computer program read from the removable media 45 is installed in the RAM 40 or the HDD 43, as necessary.

The tuner 31 tunes the digital broadcast signal of a predetermined channel input from the antenna 11 under the control of the CPU 38, that is, selects a channel to supply the digital broadcast signal to the decoder 32.

The decoder 32 demodulates the digital-modulated digital broadcast signal supplied from the tuner 31 and supplies the demodulated digital broadcast signal to the separator 33.

In a case of a digital broadcast, for example, the digital data input to the tuner 31 via the antenna 11 and demodulated by the decoder 32 is a transport stream made by multiplexing AV data compressed in the MPEG2 (Moving Picture Experts Group 2) scheme and data to be used as broadcast data. The AV data are image data and voice data forming a main portion of a broadcast program (hereinafter, simply referred to as a program) as contents. The data to be used as broadcast data contains data (for example, EPG data formed by text data) incidental to the main portion of the broadcast program and associated with the main portion of the broadcast program.

The separator 33 separates the transport stream supplied from the decoder 32 into the AV data compressed in the MPEG2 scheme, for example, and the data to be used as broadcast data containing the EPG data. The separated data to be used as broadcast data is supplied and recorded in the HDD 43 via the bus 46 and the I/F 42.

The separator 33 further separates the AV data into compressed image data and compressed voice data, when the received program (contents) is requested for view. The separator 33 supplies the separated image data and the separated voice data to the image processing unit 34 and the voice processing unit 35, respectively.

When the separator 33 receives an instruction to record the received program in the HDD 43, the separator 33 supplies the non-separated AV data (which is the AV data formed by the multiplexed image data and voice data) to the HDD 43 via the bus 46 and the I/F 42.

When the separator 33 receives an instruction to play a program recorded in the HDD 43, the separator 33 acquires the AV data from the HDD 43 via the bus 46 and the I/F 42, separates the AV data into the compressed image data and the compressed voice data, and supplies the image data and the voice data to the image processing unit 34 and the voice processing unit 35, respectively.

The image processing unit 34 decodes the compressed image data supplied from the separator 33 and supplies an image signal obtained from the decoding result to the display control unit 36.

The voice processing unit 35 decodes the compressed voice data supplied from the separator 33 and supplied a voice signal obtained from the decoding result to the output control unit 37.

The display control unit 36 controls displaying an image to a display unit 61 included in the television receiver 13 on the basis of the image signal supplied from the image processing unit 34. The display control unit 36 controls displaying the outlines of the programs (program outline) stored in the HDD 43 to the display unit 61 on the basis of the EPG data stored in the HDD 43 and included in the data to be used as broadcast data.

The output control unit 37 controls outputting a voice to the voice outputting unit 62 included in the television receiver 13 on the basis of the voice signal supplied from the voice processing unit 35.

The CPU 38 executes a program stored in advance in the ROM 39 or a program stored in the RAM 40 or the HDD 43 to control the HDD recorder 12 as a whole and executes a process to realize various functions of the HDD recorder 12.

Examples of the process executed by the CPU 38 include a channel selecting process, a record process executed in record reservation, a keyword registering process, a program search process executed in accordance with the registered keyword, an automatic program recording process, and a program outline displaying process, which is described below.

The communication unit 41 carries out wired communication using a telephone line or a cable or wireless communication under the control of the CPU 38. For example, the communication unit 41 carries out communication with a predetermined server or a predetermined personal computer through a network such as the Internet or an intranet. The data received in the communication unit 41 is recorded appropriately in the RAM 40 or the HDD 43 via the bus 46.

The I/F (interface) 42 controls an access of the HDD 43 to data under the control of the CPU 38.

The HDD 43 is a recording device capable of storing various data including a program or a broadcast program (contents) in a predetermined file format and capable of gaining random access. The HDD 43 is connected to the bus 46 via the I/F 42. When the contents as a program and various data such as the EPG data are supplied from the separator 33 or the communication unit 41, the HDD 43 records the contents and the data. When a request for reading the data is made, the HDD 43 outputs the recorded data.

### Exemplary Function Configuration of HDD Recorder

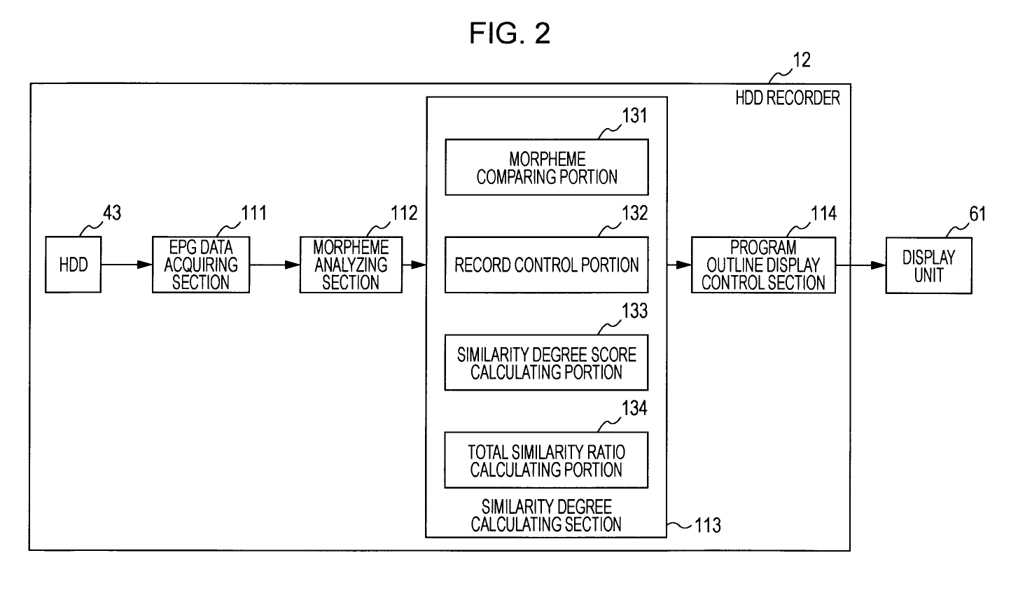

Next, an exemplary function configuration of the HDD recorder 12 which is executed by the CPU 38 will be described with reference to FIG. 2.

The HDD recorder 12 in FIG. 2 includes the HDD 43, an EPG data acquiring section 111, a morpheme analyzing section 112, a similarity degree calculating section 113, and a program outline display control section 114. The display unit 61 of the television receiver 13 (not shown) is connected to the program outline display control section 114.

The EPG data acquiring section 111 acquires the EPG data serving as data associated with the program stored in the HDD 43 from the HDD 43 and supplies to the EPG data to the morpheme analyzing section 112. More specifically, the EPG data acquiring section 111 acquires, as analysis information, “a program title”, “a program summary”, and “a program detail”, which are text data contained in the EPG data.

The morpheme analyzing section 112 separates the EPG data (“the program title”, “the program summary”, and “the program detail”) acquired by the EPG data acquiring section 111 in accordance with words of a predetermined unit, and sets attributes to the respective separated words. More specifically, the morpheme analyzing section 112 analyzes the morphemes of the EPG data acquired by the EPG data acquiring section 111 on the basis of a dictionary (a word list with information on a part of speech) stored in the ROM 39 (see FIG. 1), for example. The morpheme analyzing section 112 separates the EPG data into the smallest unit (morpheme) of a word by analyzing the morpheme and sets parts of speech to the separated morphemes.

The similarity degree calculating section 113 calculates the similarity degree between the programs corresponding to the EPG data by comparing the words (morphemes), to which the attributes (parts of speech) are set by the morpheme analyzing section 112, of the EPG data of plural programs to each other.

The similarity degree calculating section 113 includes a morpheme comparing portion 131, a record control portion 132, a similarity degree score calculating portion 133, and a total similarity ratio calculating portion 134.

The morpheme comparing portion 131 compares the morphemes, of which the parts of speech are set by the morpheme analyzing section 112, of the EPG data of the plural programs to calculate a correspondence series length, which indicates the number (length of series) of the morphemes of which the order of the parts of speech is continuously accorded, in the morphemes of the compared EPG data. For example, morpheme comparing portion 131 compares the parts of speech of the morphemes in “program titles” of two programs to each other and sets the number of morphemes, of which the order of the parts of speeds is continuously accorded in “the program titles” of the respective programs, to the correspondence series length.

The record control portion 132 controls the record process of the similarity degree calculating section 113. The record control portion 132 records the correspondence series length calculated by the morpheme comparing portion 131, for example, in the ROM 40 (see FIG. 1).

The similarity degree score calculating portion 133 calculates a similarity degree score indicating a similarity degree between the programs corresponding to the EPG data on the basis of the number of correspondence series lengths determined in accordance with the length of a series (the size of the correspondence series length) and a weight corresponding to the correspondence series length, which are stored in the RAM 40.

On the basis of the similarity degree score calculated by the similarity sore calculating portion 133, the total similarity ratio calculating portion 134 calculates a total similarity ratio indicating a comprehensive index of the similarity degree between the programs. More specifically, the total similarity ratio calculating portion 134 calculates a total similarity ratio based on the similarity degree score calculated respectively for “the program title”, “the program summary” and “the program detail” by the similarity degree score calculating portion 133.

The program outline display control section 114 controls displaying a similarity degree between a predetermined program and another program among the programs recorded in the HDD 43 on the display unit 61 displaying the program outline for a user on the basis of the total similarity ratio calculated by the total similarity ratio calculating portion 134 under the control of the display control unit 36 (not shown).

### Program Outline Displaying Process of HDD Recorder

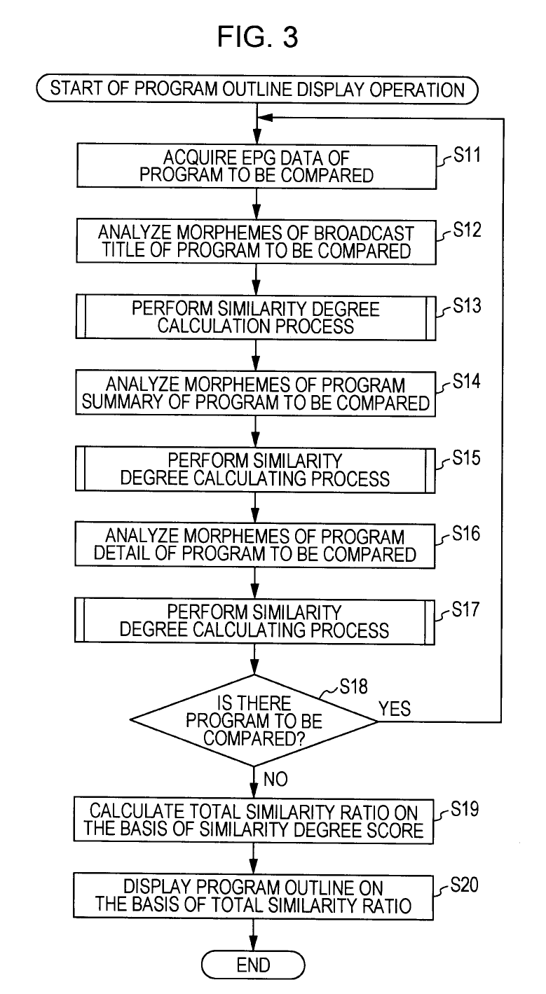

Next, a program outline displaying process of the HDD recorder 12 will be described with reference to the flowchart of FIG. 3. The program outline is displayed on the display unit 61, when the programs recorded in the HDD 43 of the HDD recorder 12 are dubbed (recorded) in the removable media 45 by an instruction of the user. The user can select a program to be dubbed in the removable media 45 among the programs recorded in the HDD 43, while the user views the program outline. In other words, the user can arrange the recorded programs, while the user views the program outline.

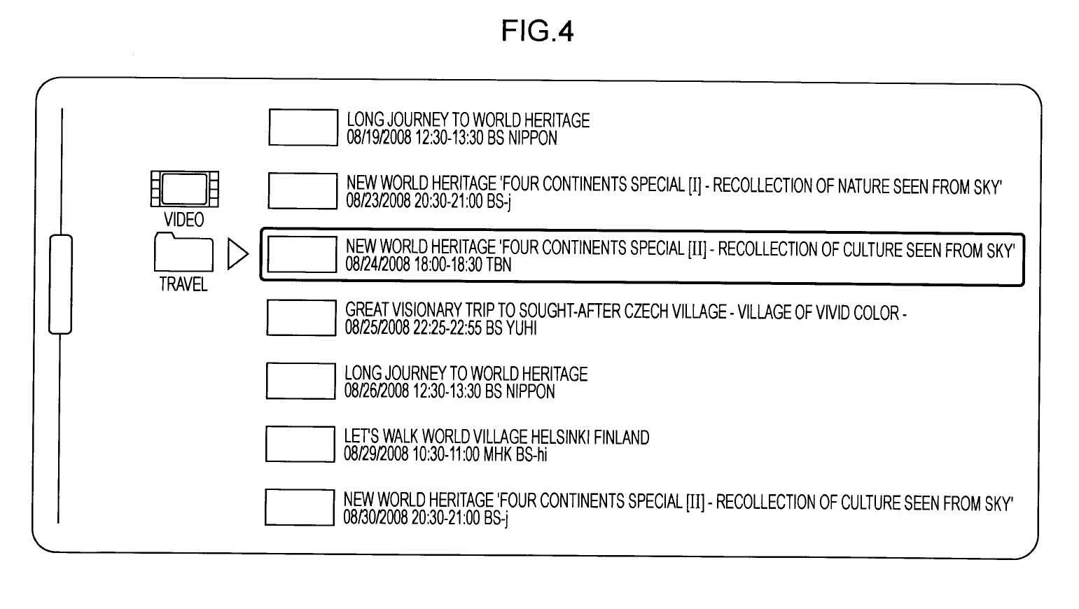

The program display process in FIG. 3 is initiated when the program outline of the programs recorded in the HDD 43, as shown in FIG. 4, is on the display unit 61 of the television receiver 13 and an operation input (not shown) is operated by the user to select a predetermine program in the program outline.

In FIG. 4, program titles, broadcast times (recording times), and broadcast stations of seven programs are shown in the program outline.

Specifically, in the program outline in FIG. 4, the program title, the broadcast time, and the broadcast station name of the uppermost program are “Long Journey to World Heritage”, 12:30 to 13:30 on Aug. 19, 2008, and “BS Nippon”, respectively. The program title, the broadcast time, and the broadcast station name of a second program from the upper side are “New World Heritage ‘Four Continents Special [I]—Recollection of Nature Seen from Sky’”, 20:30 to 21:00 on Aug. 23, 2008 and “BS-j”, respectively. The program title, the broadcast time, and the broadcast station name of a third program from the upper side are “New World Heritage ‘Four Continents Special [II]—Recollection of Culture Seen from Sky’”, 18:00 to 18:30 on Aug. 24, 2008, and “TBN”, respectively. The program title, the broadcast time, and the broadcast station name of a fourth program from the upper side are “Great Visionary Trip to Sought-after Czech Village—Village of Vivid Color”, 22:25 to 22:55 on Aug. 25, 2008, and “BS Yuhi”, respectively.

In the program outline in FIG. 4, the broadcast time, and the broadcast station name of a fifth program from the upper side are “Long Journey to World Heritage”, 12:30 to 13:30 on Aug. 26, 2008, and “BS Nippon”, respectively. The program title, the broadcast time, and the broadcast station name of a sixth program from the upper side are “Let's Walk World Village Helsinki Finland”, 10:30 to 11:00 on Aug. 29, 2008, and “MHK BS-hi”, respectively. The program title, the broadcast time, and the broadcast station name of the lowermost program are “New World Heritage ‘Four Continents Special [II]—Recollection of Culture Seen from Sky’”, 20:30 to 21:00 on Aug. 30, 2008, and “BS-j”, respectively.

For example, even though not shown, a thumbnail image or the like representing each program is shown in a rectangle on the left side of each program title.

In the program outline in FIG. 4, the third program from the upper side is surrounded by a thick frame to represent selection of the program by the operation of the user. An icon shown on the left side of the program title or the like of the selected program (hereinafter, referred to as a noticed program) represents a folder where the program displayed in the program outline is recorded (stored). That is, the programs shown in the program outline in FIG. 4 are stored in a “travel” folder of a “video” folder. A scroll bar is displayed at the left end of the program outline in FIG. 4.

The scroll bar includes a knob portion (knob) representing the location of a program currently displayed among the entire program outline and a portion (rail) along which the knob moves vertically in the scroll bar. The vertical length of the scroll bar represents a ratio of the number of programs currently displayed with respect to the number of all programs. That is, the program outline in FIG. 4 represents that there are programs (program titles or the like) above and below the seven programs displayed.

In step S11, the EPG data acquiring section 111 acquires the EPG data of the noticed program in the program outline and EPG data of a program (hereinafter, referred to as a comparison target program), which is a program other than the noticed program in the program outline and is compared to the noticed program to calculate a similarity degree, from the HDD 43. The EPG data acquiring section 111 supplies the EPG data (text data) of the acquired two programs (the noticed program and the comparison target program) to the morpheme analyzing section 112.

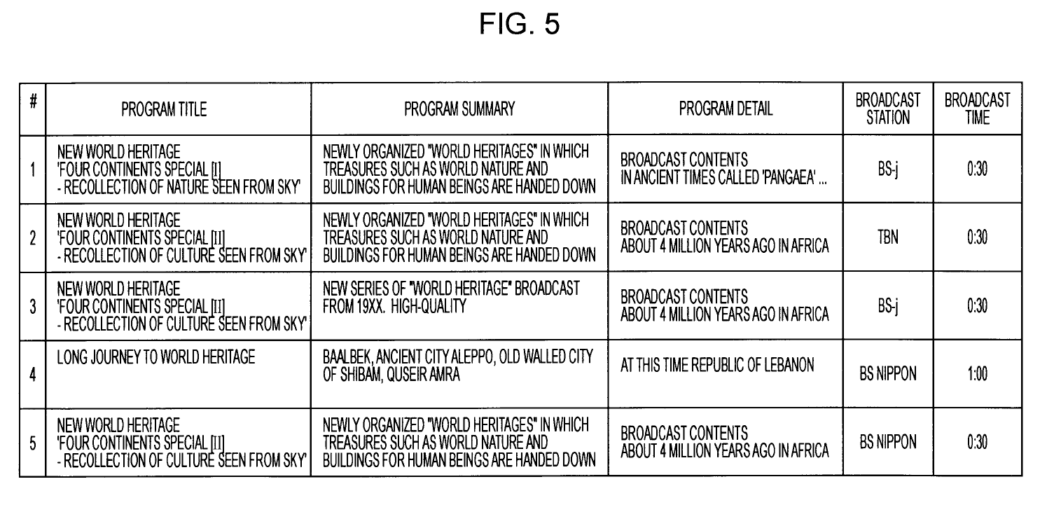

An exemplary configuration of the EPG data acquired by EPG data acquiring section 111 and used in this embodiment among the EPG data recorded in the HDD 43 is shown in FIG. 5. FIG. 5 shows “program titles”, “program summaries”, “program details”, “broadcast stations”, and “broadcast times” as the EPG data of five programs. Here, in FIG. 5, the uppermost program is referred to as program 1, a second program from the upper side is referred to as program 2, and in this way, the lowermost program is referred to as program 5. That is, as for program 1, a program title is “New World Heritage ‘Four Continents Special [I]—Memory of Nature Seen from Sky’”, a program summary is “newly organized ‘World Heritages’ in which treasures such as world nature and buildings for human beings are handed down”, a program detail is “in ancient times called ‘Pangaea’”, a broadcast station is “BS-j”, and a broadcast time is “0:30” indicating 30 minutes. The sign at the end of the program detail “ . . . ” represents a sentence continues in the EPG data in effect, but the description is omitted for simple expression. As for program 2, a program title is “New World Heritage ‘Four Continents Special [II]—Recollection of Culture Seen from Sky’”, a program summary is “newly organized ‘World Heritages’ in which treasures such as world nature and buildings for human beings are handed down”, a program detail is “about four million years ago in Africa”, a broadcast station is “TBN”, and a broadcast time is “0:30” indicating 30 minutes. As for program 3, a program title is “New World Heritage ‘Four Continents Special [II]—Recollection of Culture Seen from Sky’”, a program summary is “new series of ‘World Heritage’ broadcast since 19xx. High-quality . . . ”, a program detail is “about four million years ago in Africa”, a broadcast station is “BS-j”, and a broadcast time is “0:30” indicating 30 minutes. As for program 4, a program title is “Long Journey to World Heritage”, a program summary is “Baalbek, ancient city Aleppo, old walled city of Shibam, Quseir Amra”, a program detail is “at this time Republic of Lebanon”, a broadcast station is “BS Nippon”, and a broadcast time is “1:00” indicating 1 hour. As for program 5, a program title is “New World Heritage ‘Four Continents Special [II]—Memory of Culture Seen from Sky’”, a program summary is “newly organized “World Heritage” in which treasures such as world nature and buildings for human beings are handed down”, a program detail is “about four million years ago in Africa”, a broadcast station is “TBN”, and a broadcast time is “0:30” indicating 30 minutes.

In the flowchart of FIG. 3, in step S12, the morpheme analyzing section 112 separates the morphemes by analyzing the morphemes of “the program title” among the EPG data acquired by the EPG data acquiring section 111 and sets parts of speech to the separated morphemes.

In Step S13, the similarity degree calculating section 113 calculates the similarity degree by comparing the morphemes of “the program title” of the noticed program and “the program title” of the comparison target program to each other, the morphemes of which the parts of speech are set by the morpheme analyzing section 112.

### Similarity Degree Calculating Process of Similarity Degree Calculating Section

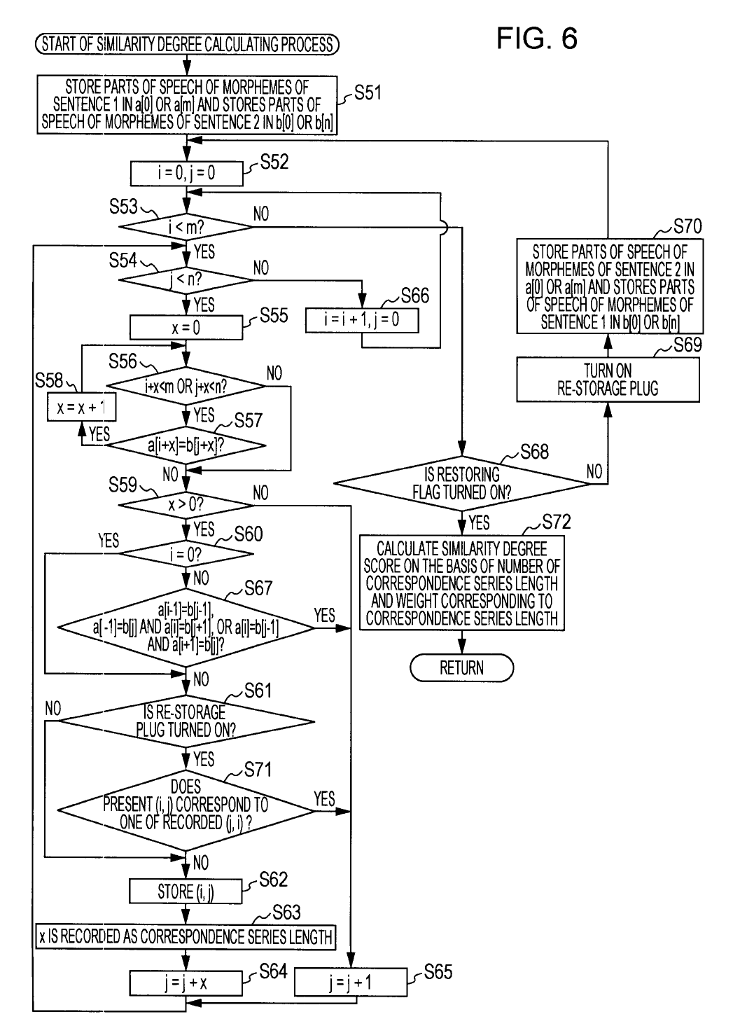

Here, the similarity degree calculating process of step S13 will be described in detail with reference to the flowchart of FIG. 6.

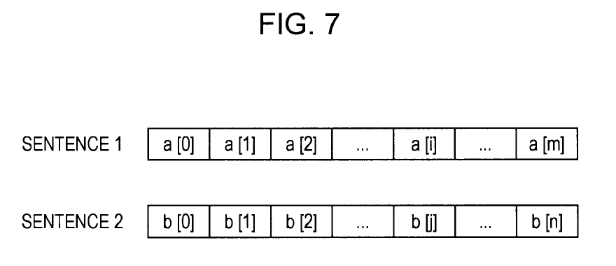

In Step S51, the morpheme comparing portion 131 stores the parts of speech of the morphemes of “the program title” (hereinafter, referred to as sentence 1) of the noticed program set by the morpheme analyzing section 112 in arrangements a[0] to a[m] (where m≧1) shown in FIG. 7. Likewise, the morpheme comparing portion 131 stores the parts of speech of the morphemes of “the program title” (hereinafter, referred to as sentence 2) of the comparison target program set by the morpheme analyzing section 112 in arrangements b[0] to b[n] (where n≧1) shown in FIG. 7. Here, an m value is a value obtained by subtracting 1 from the total number of morphemes of sentence 1 and an n value is a value obtained by subtracting 1 from the total number of morphemes of sentence 2.

FIG. 7 is a diagram illustrating the structure of arrangements a[0] to a[m] and the structure of arrangements b[0] to b[n] in which the parts of speech of the morphemes are stored. In FIG. 7, arrangements a[0] to a[m] on the upper part include m+1 arrangements a[i] (where 0≦i≦m) and the part of speech of an i-th morpheme included in sentence 1 is stored in the arrangement a[i]. Likewise, arrangements b[0] to b[n] on the lower part include n+1 arrangements b[j] (where 0≦j≦n) and the part of speech of a j-th morpheme included in sentence 2 is stored in the arrangement b[j]. In the following description, the part of speech of the i-th morpheme included in sentence 1 is located in arrangement a[i].

In Step S52, the morpheme comparing portion 131 sets i=0 and j=0 for the parameters i and j.

In step S53, the morpheme comparing portion 131 determines whether the parameter i is smaller than the m value. That is, the morpheme comparing portion 131 determines whether an i-th part of speech (hereinafter, referred to as a noticed part of speech of sentence 1) among the parts of speech of the morphemes included in sentence 1 is the last (m-th) part of speech among the parts of speech of the morphemes included in sentence 1. Since a relation of i=0 is satisfied in step S53 of a first time, it is determined that the parameter i is smaller than the m value and the process proceeds to step S54.

In Step S54, the morpheme comparing portion 131 determines whether the parameter j is smaller than the n value. That is, the morpheme comparing portion 131 determines whether a j-th part of speech (hereinafter, referred to as a noticed part of speech of sentence 2) among the parts of speech of the morphemes included in sentence 2 is the last (n-th) part of speech among the parts of speech of the morphemes included in sentence 2. Since a relation of j=0 is satisfied in step S54 of a first time, it is determined that the parameter j is smaller than the n value and the process proceeds to step S55.

In step S55, the morpheme comparing portion 131 sets x=0 for a parameter x. The parameter x will be described in detail below.

In step S56, the morpheme comparing portion 131 determines whether the sum of the parameter i and the parameter x and the sum of the parameter j and the parameter x satisfy relations of i+x<m and j+x<n. More specifically, the morpheme comparing portion 131 determines whether an i+x-th part of speech (hereinafter, referred to as a comparison target part of speech of sentence 1) of the morpheme in sentence 1 is not the final (m-th) part of speech (that is, the part of speech is present in arrangements a[0] to a[m]) and a j+x-th part of speech (hereinafter, referred to as a comparison target part of speech of sentence 2) of the morpheme in sentence 2 is not the final (n-th) part of speech (that is, the part of speech is present in arrangements b[0] to b[n]). In step S56 of a first time, since relations of i+x=0 and j+x=0 are satisfied, it is determined that the relations of i+X<m and j+x<n are satisfied, and then the process proceeds to step S57.

In step S57, the morpheme comparing portion 131 determines whether the component of arrangement a[i+x] storing the comparison target part of speech of sentence 1 corresponds to the component of arrangement b[j+x] storing the comparison target part of speech of sentence 2. In other words, the morpheme comparing portion 131 determines whether the comparison target part of speech of sentence 1 corresponds to the comparison target part of speech of sentence 2. For example, in step S57 of a first time, it is determined whether the comparison target part of speech of sentence 1 stored in arrangement a[0] corresponds to the comparison target part of speech of sentence 2 stored in arrangement b[0].

In step S57, when it is determined that the comparison target part of speech of sentence 1 corresponds to the comparison target part of speech of sentence 2, the process proceeds to step S58 and the morpheme comparing portion 131 increases the parameter x by 1. Subsequently, the process returns to step S56. The processes from step S56 to step S58 are repeated until it is determined that the relations of i+x<m and j+x<n are not satisfied in step S56 or the comparison target part of speech of sentence 1 does not correspond to the comparison target part of speech of sentence 2 in step S57.

The parameter x is increased by 1, whenever the processes from step S56 to step S58 are repeated and it is determined that whether the comparison target part of speech of sentence 1 corresponds to the comparison target part of speech of sentence 2. That is, the parameter X represents the number of comparison target parts of speech of sentence 1 according with the comparison target parts of speech of sentence 2, that is, the correspondence series length.

Alternatively, the process proceeds to step S59, when it is determined in step S56 that the relations of i+X<m and j+x<n are not satisfied, that is, the comparison target part of speech of sentence 1 is not present in arrangements a[0] to a[m] or the comparison target part of speech of sentence 2 is not present in arrangements b[0] to b[n].

The process proceeds to step S59, when it is determined that the comparison target part of speech of sentence 1 does not correspond to the comparison target part of speech of sentence 2 in step S57.

In step S59, the morpheme comparing portion 131 determines whether a relation of x>0 is satisfied for the parameter x.

The process proceeds to step S60, when the relation of x>0 is satisfied in step S59, that is, the comparison target parts of speech of sentence 2 correspond to the comparison target parts of speech of sentence 1 at least once continuously.

In step S60, the morpheme comparing portion 131 determines whether a relation of i=0 is satisfied for the parameter i, that is, the noticed part of speech of sentence 1 is the initial part of speech among the parts of speech of the morphemes of sentence 1. In step S59 of a first time, since the relation of i=0 is satisfied, the process proceeds to step S61.

In step S61, the morpheme comparing portion 131 determines whether a restoring flag is turned on. As described below, the restoring flag is a flag which is turned on when the parts of speech of the morphemes of sentence 2 stored in arrangements b[0] to b[n] are stored in arrangements a[0] to a[m] and the parts of speech of the morphemes of sentence 1 stored in arrangements a[0] to a[m] are stored in arrangements b[0] to b[n] (step S70). In step S61 of a first time, the process proceeds to step S62, since the restoring flag is not turned on.

In step S62, the record control portion 132 records the parameter i and the parameter j (hereinafter, also referred to as a parameter set (i, j)) at this time in the RAM 40. That is, the record control portion 132 controls the recording of the position of the noticed part of speech of sentence 1 stored in arrangements a[0] to a[m] and the position of the noticed part of speech of sentence 2 stored in arrangements b[0] to b[n] at this time.

In step S63, the record control portion 132 records the parameter x at this time as the correspondence series length in the RAM 40.

In step S64, the morpheme comparing portion 131 sets a relation of j=j+x for the parameter j. That is, the morpheme comparing portion 131 sets the comparison target part of speech of sentence 2 at this time to the noticed part of speech of sentence 2. The process returns to step S54 after step S64 and the subsequent processes are repeated.

Alternatively, when it is determined that the relation of x>0 is not satisfied in step S59, that is, when at least one of the comparison target parts of speech of sentence 1 does not correspond to the comparison target parts of speech of sentence 2 at all, the process proceeds to step S65.

In step S65, the morpheme comparing portion 131 increases the parameter j by 1. That is, the morpheme comparing portion 131 shifts the noticed part of speech of sentence 2 in arrangements b[0] to b[n] in FIG. 7 to the right side by one. After step S65, the process returns to step S54 and the subsequent processes are repeated.

For example, when the parts of speech of the morphemes of sentence 1 stored in arrangements a[0], a[1], and a[2] correspond to the parts of speech of the morphemes of sentence 2 stored in arrangements b[0], b[1], and b[2], respectively, in FIG. 7, the processes from step S56 to step S58 are repeated three times and a relation of x=3 is set. In step S56 of a fourth time, the positions of the noticed parts of speech of sentences 1 and 2 are arrangements a[0] and b[0], respectively, and the positions of the comparison target parts of speech of sentences 1 and 2 are arrangements a[3] and b[3], respectively. In step S57 of a fourth time, the parts of speech in arrangements a[3] and b[3] do not correspond to each other, and thus the process proceeds to step S59. Subsequently, the process proceeds to steps S60 and S61. In step S62, a parameter set (i, j)=(0, 0) is recorded. In step S63, the relation of x=3 is recorded as the correspondence series length. In step S64, the part of speech stored in arrangement b[3] is the noticed part of speech of sentence 2 and the process returns to step S54. That is, the positions of the noticed parts of speech of sentences 1 and 2 are arrangements a[0] and b[3], respectively, and the process proceeds to the subsequent step.

In this way, the processes from step S54 to S65 are repeated. When the noticed part of speech of sentence 2 is the part of speech (the final part of speech among the parts of speech of the morphemes of sentence 2) stored in arrangement b[n], it is determined in step S54 that the parameter j is not smaller than the n value, and then the process proceeds to step S66.

In step S66, the morpheme comparing portion 131 increases the parameter i by 1 and sets a relation of j=0 for the parameter j. That is, the morpheme comparing portion 131 shifts the noticed part of speech of sentence 1 in arrangements a[0] to a[m] in FIG. 7 to the right side by one and the position of the noticed part of speech of sentence 2 to arrangement b[0]. In step S66 of a first time, since a relation of i=1 is satisfied, the noticed parts of speech of sentences 1 and 2 are located in arrangements a[1] and b[0], respectively, and then the process returns to step S53.

Subsequently, the process continues in the state where the noticed parts of speech of sentences 1 and 2 are located in a[1] and b[0]. In step S60, since the relation of i=1, the process proceeds to step S67.

In step S67, the morpheme comparing portion 131 determines whether one of conditions 1 to 3 described below is satisfied.

Condition 1: the part of speech stored in arrangement a[i−1] on the left side of the noticed part of speech of sentence 1 by one corresponds to the part of speech stored in arrangement b[j−1] on the left side of the noticed part of speech of sentence 2 by one.

Condition 2: the part of speech stored in arrangement a[i−1] on the left side of the noticed part of speech of sentence 1 by one corresponds to the part of speech of sentence 2, and the noticed part of speech of sentence 1 corresponds to the part of speech stored in arrangement b[j+1] on the right side of the noticed part of speech of sentence 2 by one.

Condition 3: the noticed part of speech of sentence 1 corresponds to the part of speech stored in arrangement b[j−1] on the right side of the noticed part of speech of sentence 2 by one, and the part of speech stored in arrangement a[i+1] on the right side of the noticed part of speech of sentence 1 by one corresponds to the noticed part of speech of sentence 2.

In step S67, when it is determined whether one of conditions 1 to 3 is satisfied, the process proceeds to step S65 and the morpheme comparing portion 131 increases the parameter j by 1. That is, the morpheme comparing portion 131 shifts the noticed part of speech of sentence 2 to the right side by one in arrangements b[0] to b[n] in FIG. 7. After step S65, the process returns to step S54 and the subsequent processes are repeated.

For example, in FIG. 7, the parts of speech of the morphemes of sentence 1 stored in arrangements a[0], a[1], and a[2] correspond to the parts of speech of the morphemes of sentence 2 stored in arrangements b[0], b[1], and b[2], respectively. When the noticed parts of speech of sentences 1 and 2 are located in arrangements a[1] and b[0], respectively, a relation of x=2 is satisfied. This is because the comparison target parts of speech of sentence 1 stored in arrangements a[1] and a[2] correspond to the comparison target parts of speech of sentence 2 stored in arrangements b[1] and b[2], respectively. In this state, when the process proceeds to steps S60, S61, and S67, it is determined that condition 2 is satisfied in step S67 and the process proceeds to step S65. At this time, since the process of step S63 is not executed, there is no case where x=2 is recorded as the correspondence series length.

That is, in the process of step S67, it is possible to prevent the recorded correspondence series length from being determined as the correspondence series length partially in the obtained arrangement.

Alternatively, when it is determined that any one of conditions 1 to 3 is not satisfied in step S67, the process proceeds to step S61 and the subsequent processes are repeated.

In this way, when the processes from step S54 to S67 are repeated and the noticed part of speech of sentence 1 becomes the part of speech (which is the final part of speech among the parts of speech of the morphemes of sentence 1) stored in arrangement a[m] in step S66, it is determined that the parameter i is not smaller than the m value in step S53, and then the process proceeds to step S68.

In step S68, the morpheme comparing portion 131 determines whether the restoring flag is turned on. In step S68 of a first time, since the restoring flag is not turned on, the process proceeds to step S69, and then the morpheme comparing portion 131 turns on the restoring flag.

In step S70, the morpheme comparing portion 131 stores the parts of speech of the morphemes of sentence 2 in arrangement a[0] to a[m] (where m≧1) and the parts of speech of sentence 2 are stored in arrangement b[0] to b[n] (where n≧1). That is, the morpheme comparing portion 131 replaces and restores sentences 1 and 2 stored in arrangements a[0] to a[m] and arrangements b[0] to b[n] so far. Here, the m value is a value obtained by subtracting 1 from the total number of morphemes of sentence 2 and the n value is a value obtained by subtracting 1 from the total number of morphemes of sentence 1. After step S70, the process returns to step S52 and the subsequent processes are repeated.

When it is determined that one of conditions 1 to 3 is satisfied in step S67 during the repetition of the processes subsequent to step S52, the process proceeds to step S61. Here, in step S61, since it is determined that the restoring flag is turned on, the process proceeds to step S71.

In step S71, the morpheme comparing portion 131 determines whether the present parameter set (i, j) corresponds to one of the parameter sets (j, i) obtained by reversing the parameter sets (i, j) stored in the RAM 40.

When it is determined that the present parameter set (i, j) corresponds to one of the parameter sets (j, i) obtained by reversing the parameter sets (i, j) stored in the RAM 40 in step S71, the process proceeds to step S65.

Alternatively, when it is determined in step S71 that the present parameter set (i, j) does not correspond to any one of the parameter sets (j, i) obtained by reversing the parameter sets (i, j) stored in the RAM 40, the process proceeds to step S62.

For example, when the parts of speech of the morphemes of sentence 1 stored in arrangements a[0], a[1], and a[2] in step S51 (first storing process) correspond to the parts of speech of the morphemes of sentence 2 stored in arrangements b[0], b[1], and b[2], parameters sets (i, j)=(0, 0) and the correspondence series length of 3 are recorded in the RAM 40. In step S70 (restoring process), the parts of speech of the morphemes of sentence 2 are stored in arrangements a[0], a[1], and a[2] and the parts of speech of the morphemes of sentence 1 are stored in arrangements b[0], b[1], and b[2]. Here, even when sentences 1 and 2 stored in arrangements a[0] to a[m] and arrangements b[0] to b[n], respectively, are replaced with each other, the parts of speech stored in arrangements a[0], a[1], and a[2] and arrangements b[0], b[1], and b[2] correspond to each other. That is, the parameter x indicating the correspondence series length satisfies the relation of x=3. At this time, the positions of the noticed parts of speech of sentences 1 and 2 become arrangements a[0] and b[0]. Subsequently, in step S71, it is determined whether the present parameter set (i, j)=(0, 0) corresponds to one of the parameter sets (j, i) obtained by reversing the parameter sets (i, j) stored in the RAM 40. At this time, the parameter set (i, j)=(0, 0) is recorded together with the correspondence series length of 3 in the RAM 40. In addition, since the parameter set (j, i)=(0, 0) obtained by reversing the parameter set (i, j)=(0, 0) corresponds to the parameter set (i, j)=(0, 0), the process proceeds to step S65. That is, since the process of step S63 is not executed, there is no case where x=3 is recorded as the correspondence series length.

That is, in the processes of steps S61 and S71, it is possible to prevent the correspondence series length, which is substantially same as the correspondence series length obtained by the comparison between the parts of speech in the first storing process, from being repeatedly obtained by the comparison between the parts of speech in the second storing process.

In this way, even after the restoring process, the processes from step S54 to S66 and the process of step S71 are repeated. When the noticed part of speech of sentence 2 becomes the part of speech (which is the final part of speech among the parts of speech of the morphemes of sentence 2) stored in arrangement a[m] in step S66, it is determined that the parameter i is not smaller than the m value in step S53, and then the process proceeds to step S67 of a second time.

In step S67 of a second time, it is determined that the restoring flag is turned on, and then the process proceeds to step S72.

In this way, while the position of the noticed part of speech of sentence 1 and the position of the noticed part of speech of sentence 2 are shifted to the right side, the comparison target part of speech of sentence 1 is compared to the comparison target part of speech of sentence 2 and the parts of speech are again compared to obtain the correspondence series length by replacing sentences 1 and 2 with each other.

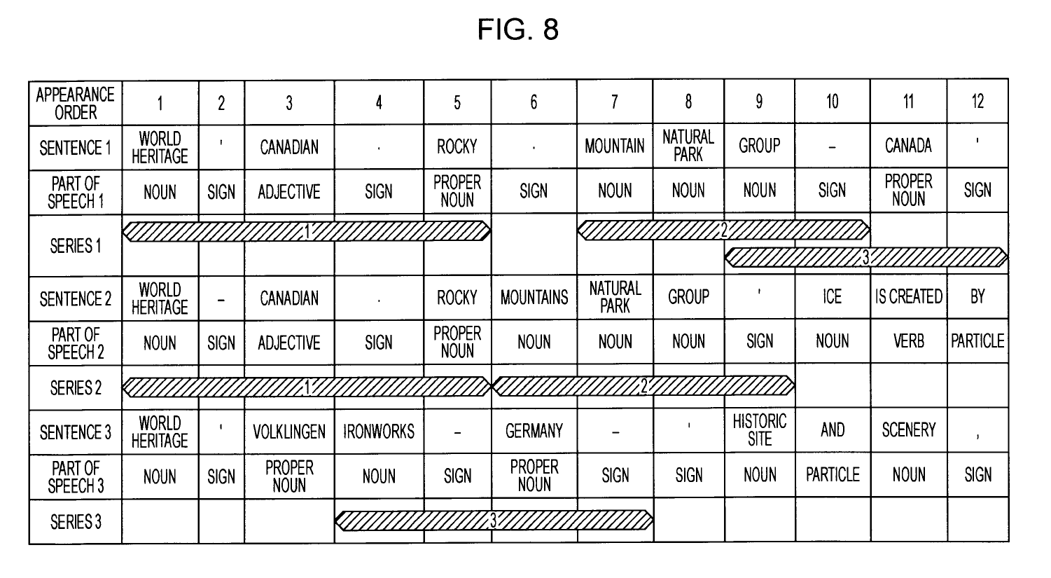

FIG. 8 is a diagram illustrating an example of the correspondence series length obtained by comparing the parts of speech of the morphemes of the program title serving as the EPG data, as described above.

FIG. 8 shows the correspondence series length obtained when sentences 1 and 2 are compared and sentences 1 and 3 are compared.

As shown in FIG. 8, sentence 1 “World Heritage ‘Canadian•Rocky•Mountain Natural Park Group—Canada’” are separated into morphemes of “World Heritage”=noun, “′”=sign, “Canadian”=adjective, “•”=sign, “Rocky”=proper noun, “•”=sign, “Mountain”=noun, “Natural Park”=noun, “Group”=noun, “′”=sign, “Canada”=proper noun, and “′”=sign, and parts of speech (part of speech 1 in FIG. 8) thereof are set.

In addition, sentence 2 “World Heritage—Canadian Rocky Mountains Natural Park Group ‘Ice Is Created by’” are separated into morphemes of “World Heritage”=noun, “—”=sign, “Canadian”=adjective, “•”=sign, “Rocky”=proper noun, “Mountains”=noun, “Natural Park”=noun, “Group”=noun, “′”=sign, “Ice”=noun, and “Is Created”=verb, and “by”=particle, and parts of speech (part of speech 2 in FIG. 8) thereof are set.

In addition, sentence 3 “World Heritage ‘Volklingen Ironworks—Germany—’ Historic Site And Scenery,” are separated into morphemes of “World Heritage”=noun, “′”=sign, “Volklingen”=noun, “Ironworks”=noun, “—”=sign, “Germany=proper noun, “—”=sign, “′”=sign, “Historic Site”=noun, “And”=particle, “Scenery”=noun, and “,”=sign, and parts of speech (part of speech 3 in FIG. 8) thereof are set.

When the morphemes of sentence 1 and the morphemes of sentence 2 are compared to each other, series of parts of speech (the noun, the sign, the adjective, the sign, and the proper noun) of the morphemes indicated by the line written by numeral 1 in columns of series 1 and series 2 correspond to each other in FIG. 8. That is, one correspondence series length of 5 is obtained. In addition, in FIG. 8, series of parts of speech (the noun, the noun, the noun, and the sign) of the morphemes indicated by the line written by numeral 2 in columns of series 1 and series 2 correspond to each other. That is, one correspondence series length of 4 is obtained.

Likewise, when the morphemes of sentence 1 and the morphemes of sentence 3 are compared to each other, a series of parts of speech (the noun, the sign, the proper noun, and the sign) of the morphemes indicated by the line written by numeral 3 in columns of series 1 and series 3 correspond to each other in FIG. 8. That is, one correspondence series length of 4 is obtained.

In this way, the parts of speech of the morphemes are compared to obtain the correspondence series length.

Returning to the flowchart of FIG. 6 again, the similarity degree score calculating portion 133 calculates the similarity degree score representing the similarity degree between the programs corresponding to the EPG data on the basis of the correspondence series length and the weight corresponding to the correspondence series length recorded in the RAM 40 in step S72.

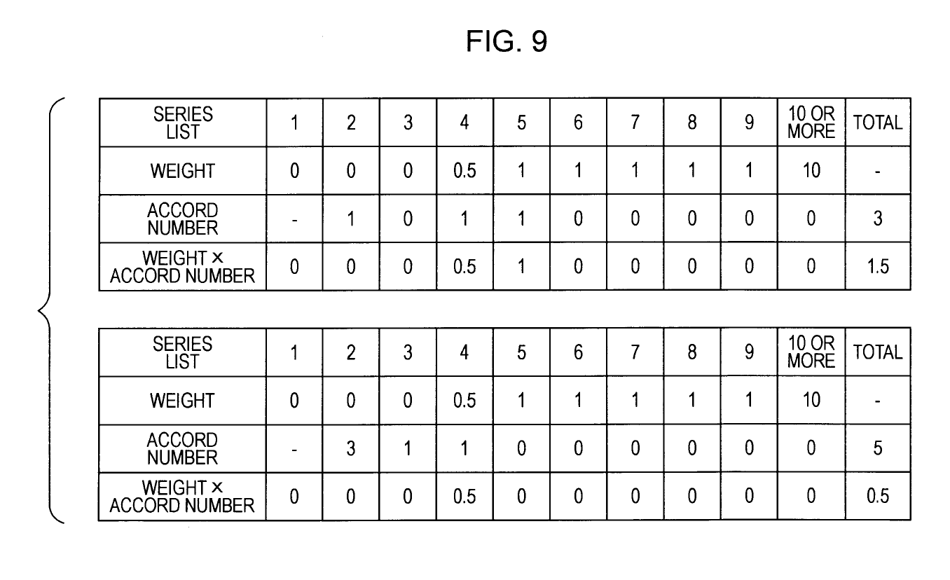

Hereinafter, an exemplary calculation of the similarity score by the similarity degree score calculating portion 133 will be described with reference to FIG. 9.

In the upper part of FIG. 9, an exemplary calculation of the similarity degree score between sentences 1 and 2 described in FIG. 8 is shown. In the upper part of FIG. 9, weights are set for the series lengths (correspondence series lengths) of 1 to 10 or more. More specifically, a weight of 0 is set for the series lengths of 1 to 3, a weight of 0.5 is set for the series length of 4, a weight of 1 is set for the series lengths of 5 to 9, and a weight of 10 is set for the series lengths of 10 or more. The accord number is the number of respective series lengths (correspondence series lengths) stored in the RAM 40 and represents the number of correspondence series lengths obtained for sentences 1 and 2 described in FIG. 8. Moreover, since the series length of 1 just means that the accord number of parts of speech between sentences 1 and 2 is one and there is no special meaning, the number of series lengths of 1 is not counted. For this reason, the weight of 0 is set for the series length of 1. The total sum of the product of the accord number of correspondence series lengths obtained in this way and the weights for the correspondence series lengths is calculated as the similarity degree score of sentences 1 and 2. Specifically, the sum of the product (=0) of accord number 1 of series length 2 and weight 0 for series length 2, the product (=0.5) of accord number 1 of series length 4 and weight 0.5 for series length 4, and the product (=1) of accord number 1 of series length 5 and weight 1 for series length 5 is 1.5. This sum is calculated as the similarity degree score of sentences 1 and 2. Moreover, the total sum of the accord numbers is calculated to 3.

In the lower part of FIG. 9, an exemplary calculation of the similarity degree score between sentences 1 and 3 described in FIG. 8 is shown. In the upper part of FIG. 9, like the upper part of FIG. 9, the total sum of the products of the number of the correspondence series lengths and the weights for the correspondence series lengths is calculated to the similarity degree score of sentences 1 and 3. Specifically, the sum of the product (=0) of accord number 3 of series length 2 and weight 0 for series length 2, the product (=0) of accord number 1 of series length 3 and weight 0 for series length 3, and the product (=1) of accord number 1 of series length 4 and weight 0.5 for series length 4 is 0.5. This sum is calculated as the similarity degree score of sentences 1 and 3. Moreover, the total sum of the accord numbers is calculated to 5.

On other hand, when there is the correspondence series length of 10 or more, in particular, when the text data (EPG data) to be compared are completely the same as each other, the value of the similarity degree score is set 10, for example, irrespective of the number of other correspondence series lengths.

The weights for the series lengths are not limited to the values shown in FIG. 9, but may be arbitrarily set by a user or may be set in accordance with a predetermined function, so that a larger value is taken given that the size of the series length is larger.

In FIG. 9, the weight of the series lengths of 3 or less is set to 0, which consequently has the same meaning as that of the case where it is determined whether the relation of x>3 is satisfied in step S59 in the flowchart of FIG. 6. That is, in step S59 in the flowchart of FIG. 6, a case where the correspondence series length is recorded by determining whether a relation of x>N (where N is an integer of 0 or more) is a case of N+1 or more. Accordingly, in FIG. 9, the number of series lengths of N or less is 0 and the obtained similarity degree score is the same as that of a case where the weight of a series length of N or less is set to 0.

In this way, in step S72, the similarity degree score calculating portion 133 calculates the similarity degree score for “the program title” on the basis of the number of correspondence series lengths between “the program titles” to be compared to each other and the weight corresponding to the correspondence series length. Then, the process returns to step S13 in the flowchart of FIG. 3.

In the above description, the total sum of the products of the numbers of correspondence series lengths and the weights corresponding to the correspondence series lengths is set to the similarity degree score. However, the similarity degree score may be set to a value obtained by a certain normalization process, for example, a value obtained by dividing the total sum of the accord number of series lengths by the number of parts of speech or a value obtained by dividing the sum of the correspondence series lengths of which the accord number is 1 or more by the number of words.

When the process proceeds to step S14 after step S13, the morpheme analyzing section 112 analyzes the morphemes of “the program summary” among the EPG data obtained by the EPG data acquiring section 111, separates the program outline into the morphemes, and sets parts of speech to the separated morphemes.

In step S15, the similarity degree calculating section 113 calculates the similarity degree by comparing the morphemes, of which the parts of speech are set by the morpheme analyzing section 112, between “the program outlines” of the noticed program and the comparison target program, and then calculates the similarity degree score for “the program summary”. Since the details of the similarity degree calculating process performed by the similarity degree calculating section 113 are the same as those of the similarity degree calculating process, which is described with reference to the flowchart of FIG. 6, performed for “the program summary”, the description is omitted.

In step S16, the morpheme analyzing section 112 analyzes the morphemes of “the program detail” among the EPG data obtained by the EPG data acquiring section 111, separates the program detail into the morphemes, and sets the parts of speech to the separated morphemes.

In step S17, the similarity degree calculating section 113 calculates the similarity degree by comparing the morphemes, of which the parts of speech are set by the morpheme analyzing section 112, between “the program details” of the noticed program and the comparison target program, and then calculates the similarity degree score for “the program details”. Since the details of the similarity degree calculating process, which is described with reference to the flowchart of FIG. 6, performed by the similarity degree calculating section 113 are the same as those of the similarity degree calculating process performed for “the program details”, the description is omitted.

In step S18, the EPG data acquiring section 111 determines whether there is a program to be compared to the noticed program, that is, whether there are the EPG data of a program other than the present noticed program and the comparison target program (whether the EPG data are stored in the HDD 43).

When it is determined that there is a program to be compared to the noticed program in step S18, the process returns to step S11 and the process from step S11 to S18 are repeated. In step S11 after a second time, the EPG data acquiring section 111 acquires only the EPG data of a program set as a new comparison target program from the HDD 43.

Alternatively, when it is determined that there is no program to be compared to the noticed program in step S18, the process proceeds to step S19.

In step S19, the total similarity ratio calculating portion 134 calculates a total similarity ratio serving as the comprehensive index of the similarity degree between the programs on the basis of the similarity degree score calculated for each of “the program title”, “the program summary” and “the program detail” by the similarity degree score calculating portion 133.

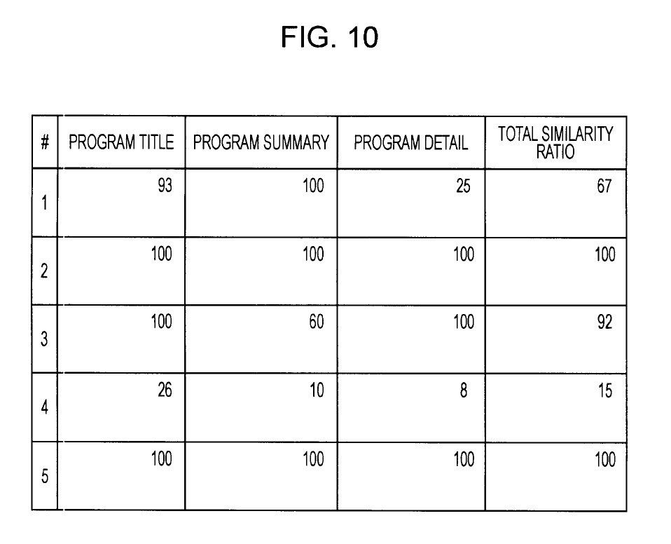

Here, an exemplary calculation of the total similarity ratio by the total similarity ratio calculating portion 134 will be described with reference to FIG. 10.

FIG. 10 shows the similarity degree scores and the total similarity ratios of “the program titles”, “the program summaries” and “the program details”, when “program 2” is set to the noticed program among “program 1” to “program 5” described in FIG. 5.

In FIG. 10, the similarity degree scores of “the program titles”, “the program summaries” and “the program details” are expressed as a relative value (hereinafter, also referred to as a similarity ratio) on the assumption that the similarity degree score of the completely same program as the noticed program (“program 2”) is 100. In addition, “a total similarity ratio” is an average value weighted at a predetermined ratio of 2:1:2, for example, for “the program titles”, “the program summaries” and “the program details”.

More specifically, the similarity ratios of “the program titles”, “the program summaries”, and “the program details” between “program 2” serving as the noticed program and “program 1” serving as the comparison target program are 93, 100, and 25, respectively, and “the total similarity ratio” is 67. The similarity ratios of “the program titles”, “the program summaries” and “the program details” between “programs 2” serving as the noticed program are all 100, and “the total similarity ratio” is also 100. The similarity ratios of “the program titles”, “the program summaries”, and “the program details” between “program 2” serving as the noticed program and “program 3” serving as the comparison target program are 100, 60, and 100, respectively, and thus “the total similarity ratio” is 92. The similarity ratios of “the program titles”, “the program summaries” and “the program details” between “program 2” serving as the noticed program and “program 4” serving as the comparison target program are 26, 10 and 8, respectively, and thus “the total similarity ratio” is 15. The similarity ratios of “the program titles”, “the program summaries” and “the program details” between “program 2” serving as the noticed program and “program 5” serving as the comparison target program are all 100, and thus “the total similarity ratio” is also 100. That is, it may be considered that “program 2” and “program 5” are the same program.

In this way, the total similarity ratio calculating portion 134 calculates the total similarity ratio on the basis of the similarity degree scores of “the program titles”, “the program summaries” and “the program details”.

Returning to the flowchart of FIG. 3 again, in step S20, the program outline display control section 114 displays the program outline on the display unit 61 to show the similarity degree of the noticed program and the comparison target program on the basis of the total similarity ratio calculated by the total similarity ratio calculating portion 134. More specifically, the program outline display control section 114 displays the program outline on the display unit 61 under the control of the display control unit 36 (see FIG. 1) so that the program of which the total similarity ratio is larger than a predetermined threshold value is not readily seen by a user.

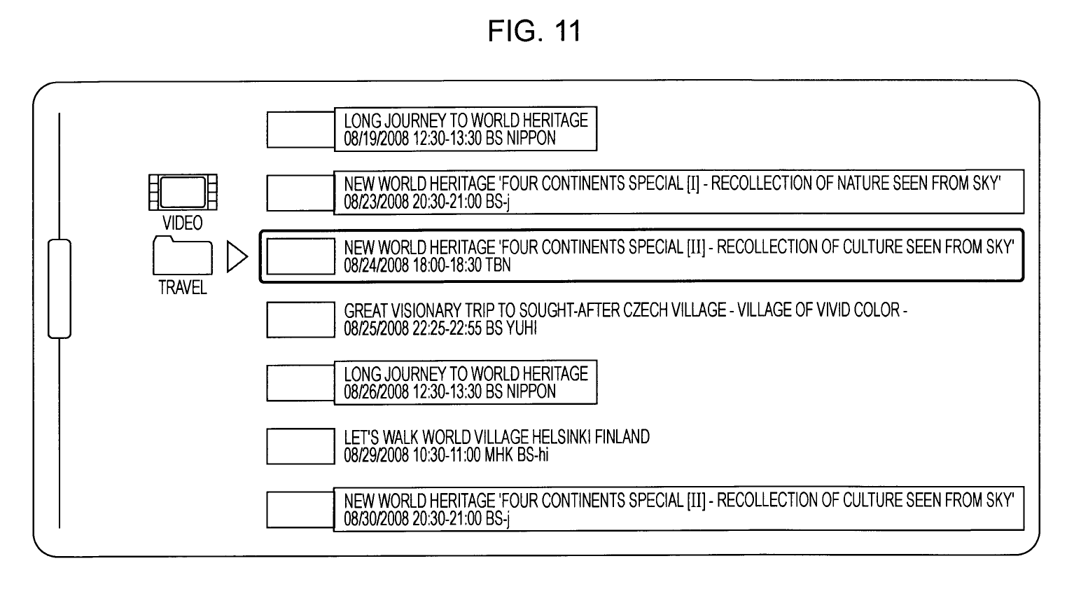

FIG. 11 is a diagram illustrating an exemplary display in which the program of which the total similarity ratio is larger than the predetermined threshold value is not readily seen by a user in the program outline described in FIG. 4. In FIG. 11, the program outline is displayed so that the background colors of the program titles of the programs are displayed with a darker gray color, as the programs have the total similarity ratio larger than the predetermined threshold value. More specifically, the background color of the program titles of the uppermost program and a fifth program from the upper side in FIG. 11 is displayed as a dim gray color. The background color of the program title of a second program from the upper side is displayed as a slightly dark gray color. The background of the program title of the lowermost program is displayed as the darkest gray color. That is, the uppermost program and the fifth program from the upper side have a slightly high similarity degree with the noticed program. The second program has the next high similarity degree with the noticed program. The lowermost program has the further high similarity degree with the noticed program.

In the above-described example, the background color is not limited to the gray color, but the programs of which the total similarity ratio is larger than the predetermined threshold value may not readily be seen by a user by changing the colors of the character such as the program title or by displaying icons, for example.

In this way, by displaying the programs of which the total similarity ratio is larger than the predetermined threshold value so as not to be readily seen by a user, the programs (which are not readily seen by the user) of the contents which are highly likely to be the same as the contents of the programs selected by the user can be set to deleting target candidate programs and the other programs can be set to dubbing target programs, when the user arranges the recorded programs while viewing the program outline.

According to the above-described process, the similarity degree score can be calculated by analyzing the morphemes of “the program titles”, “the program summaries” and “the program details” of the noticed program and the comparison target program and by calculating the correspondence series length on the basis of the series of the parts of the speech of the morphemes. In this way, by comparing the EPG data between the programs in the morpheme unit, it is possible to reduce the calculating amount, compared to a case where the EPG data are compared in accordance with characters. Moreover, since the appearance orders of the parts of speech of the morphemes can be compared to each other without using keywords, it is possible to distinguish the programs of the same contents more efficiently and more exactly.

According to the total similarity ratio calculated on the basis of the similarity degree score, the programs of which the total similarity ratio is larger than the predetermined threshold value are displayed so as not to be readily seen by a user. Therefore, the programs (which are not readily seen to the user) of the contents which are highly likely to be the same as the contents of the programs selected by the user can be set to the deleting target candidate programs and the other programs can be set to the dubbing target programs, when the user arranges the recorded programs while viewing the program outline. Accordingly, the user can efficiently arrange the recorded programs.

In the above description, the correspondence series length is calculated on the basis of the series of the parts of speech of the morphemes separated by analyzing the morphemes of the EPG data which are the text data. However, the correspondence series length may be calculated on the basis of the series of the words separated in accordance with attributes such as kinds (hereinafter, also referred to as a word kind) of a place name, a person name, a terminology or kinds (hereinafter, also referred to as a character kind) of Hiragana, Katakana, and Kanji character, for example.

### Example of Coincident Series Length in Comparison of Word Kinds

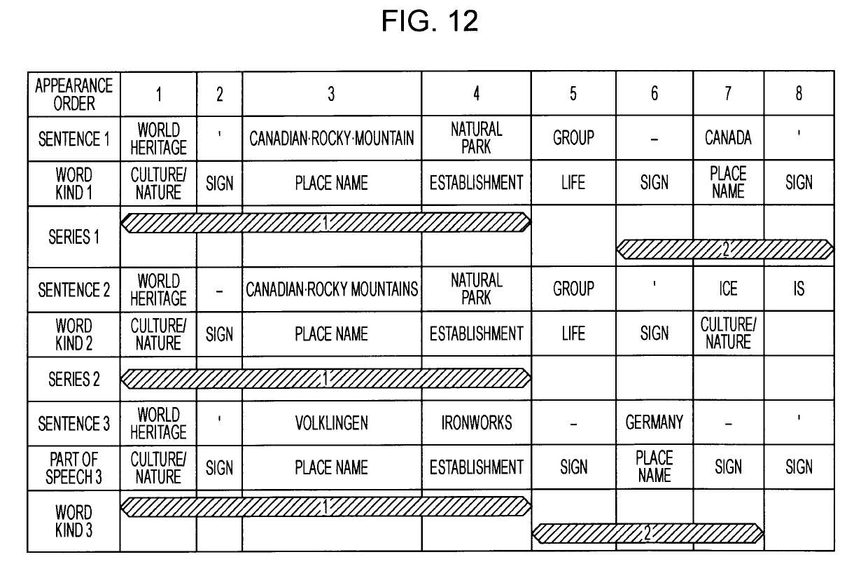

FIG. 12 is a diagram illustrating an example of the correspondence series length when the program titles serving as the EPG data are separated into words in accordance with word kinds and the word kinds of the words are compared to each other.

As in FIG. 8, FIG. 12 shows the correspondence series lengths when sentences 1 and 2 are compared and sentences 1 and 3 are compared.

As shown in FIG. 12, sentence 1 “World Heritage ‘Canadian•Rocky•Mountain Natural Park Group—Canada’” are separated into “World Heritage”=culture/nature, “′”=sign, “Canadian•Rocky•Mountain”=place name, “Natural Park”=establishment, “Group”=life, “—”=sign, “Canada”=place name, and “′”=sign, and work kinds (word kind 1 in FIG. 12) thereof are set.

In addition, sentence 2 “World Heritage—Canadian•Rocky Mountains Natural Park Group ‘Ice Is” are separated into “World Heritage”=culture/nature, “—”=sign, “Canadian•Rocky Mountain”=place name, “Natural Park”=establishment, “Group”=life, “′”=sign, “Ice”=culture/nature, and “Is”=others, and parts of speech (word kind 2 in FIG. 12) thereof are set.

In addition, sentence 3 “World Heritage ‘Volklingen Ironworks—Germany—’” are separated into “World Heritage”=culture/nature, “′”=sign, “Volklingen”=place name, “Ironworks”=establishment, “—”=sign, “Germany”=place name, “—”=sign, and “′”=sign, and the word kinds (word kind 3 in FIG. 12) thereof are set.

When the words of sentence 1 and the words of sentence 2 are compared to each other, series of the word kinds (the culture/nature, the sign, the place name, and the establishment) of the words indicated by the line written by numeral 1 in columns of series 1 and series 2 correspond to each other in FIG. 12. That is, one correspondence series length of 4 is obtained.

Likewise, when the words of sentence 1 and the words of sentence 3 are compared to each other, series of word kinds (the culture/nature, the sign, the place name, and the establishment) of the words indicated by the line written by numeral 1 in columns of series 1 and series 3 correspond to each other in FIG. 12. That is, one correspondence series length of 4 is obtained. In addition, in FIG. 12, series of word kinds (the sign, the place name, and the sign) of the words indicated by the line written by numeral 2 in columns of series 1 and series 3 correspond to each other. That is, one correspondence series length of 3 is obtained.

This process is realized by storing a dictionary serving as a word list with information on the word kinds in the ROY 39 and allowing the morpheme analyzing section 112 to separate the EPG data acquired by the EPG data acquiring section 111 on the basis of the dictionary stored in the ROM 39.

### Example of Coincident Series Length in Comparison of Character Kinds

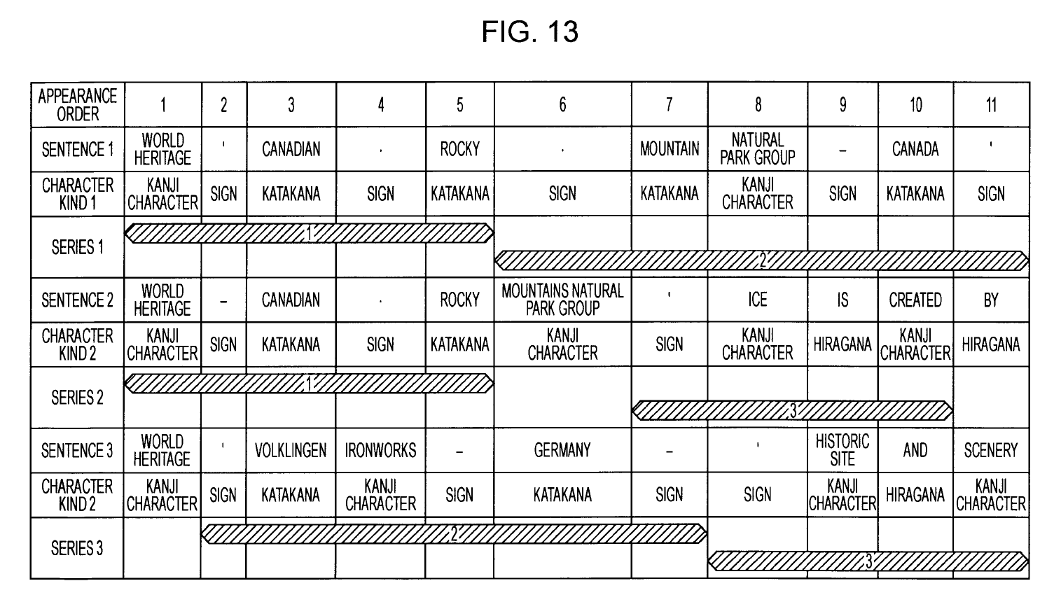

FIG. 13 is a diagram illustrating an example of the correspondence series length when the program titles serving as the EPG data are separated into words in accordance with character kinds and the character kinds of the words are compared to each other.

As in FIG. 8, FIG. 13 shows the correspondence series lengths when sentences 1 and 2 are compared and sentences 1 and 3 are compared.

As shown in FIG. 13, sentence 1 “World Heritage ‘Canadian•Rocky•Mountain Natural Park Group—Canada’” are separated into “World Heritage”=Kanji character, “′”=sign, “Canadian”=Katakana, “•”=sign, “Rocky”=Katakana, “•”=sign, “Mountain”=Katakana, “Natural Park Group”=Kanji character, “—”=sign, “Canada”=Katakana, and “′”=sign, and the character kinds (character kind 1 in FIG. 13) thereof are set.

In addition, sentence 2 “World Heritage—Canadian•Rocky Mountains Natural Park Group ‘Ice Is Created by” are separated into “World Heritage”=Kanji character, “—”=sign, “Canadian”=Katakana, “•”=sign, “Rocky”=Katakana, “Mountains Natural Park Group”=Kanji character, “′”=sign, “Ice”=Kanji character, “Is”=Hiragana, “Created”=Kanji character, and “by”=Hiragana, and the character kinds (character kind 2 in FIG. 13) thereof are set.

In addition, sentence 3 “World Heritage ‘Volklingen Ironworks—Germany—’ Historic Site And Scenery” are separated into “World Heritage”=Kanji character, “′”=sign, “Volklingen”=Katakana, “Ironworks”=Kanji character, “—”=sign, “Germany”=Katakana, “—”=sign, “′”=sign, “Historic Site”=Kanji character, “And”=Hiragana, and “Scenery”=Kanji character, and the character kinds (character kind 3 in FIG. 13) thereof are set.

When the words of sentence 1 and the words of sentence 2 are compared to each other, series of the character kinds (the Kanji character, the sign, the Katakana, the sign, and the Katakana) of the words indicated by the line written by numeral 1 in columns of series 1 and series 2 correspond to each other in FIG. 13. That is, one correspondence series length of 5 is obtained.

Likewise, when the words of sentence 1 and the words of sentence 3 are compared to each other, series of the character kinds (the sign, the Katakana, the Kanji character, the sign, the Katakana, and the sign) of the words indicated by the line written by numeral 2 in columns of series 1 and series 3 correspond to each other in FIG. 13. That is, one correspondence series length of 6 is obtained.

In addition, when the words of sentence 2 and the words of sentence 3 are compared to each other, series of the character kinds (the sign, the Kanji character, the sign, the Hiragana, and the Kanji character) of the words indicated by the line written by numeral 3 in columns of series 2 and series 3 correspond to each other in FIG. 13. That is, one correspondence series length of 4 is obtained.

This process is realized by storing a dictionary serving as a word list with information on the character kinds in the ROM 39 and allowing the morpheme analyzing section 112 to separate the EPG data acquired by the EPG data acquiring section 111 on the basis of the dictionary stored in the ROM 39.

As in the above-described example, the similarity degree score can be calculated by analyzing the morphemes of “the program titles”, “the program summaries” and “the program details” of the noticed program and the comparison target program and obtaining the correspondence series lengths on the basis of the series of the word kinds or the character kinds of the words thereof. In this way, by comparing the EPG data between the programs in the word unit corresponding to the word kinds or the character kinds, it is possible to reduce the calculating amount, compared to the case where the EPG data are compared in accordance with characters. Moreover, since the appearance orders of the word kinds or the character kinds of words can be compared to each other without using keywords, it is possible to distinguish the programs of the same contents more efficiently and more exactly.

### Another Exemplary Display of Program Outline

In the above description, the program outline is displayed so that the programs of which the total similarity ratio is larger than the predetermined threshold value are not readily seen by a user. However, on the contrary, the program outline may be displayed so that the programs of which the total similarity ratio is smaller than the predetermined threshold value are not readily seen by a user.

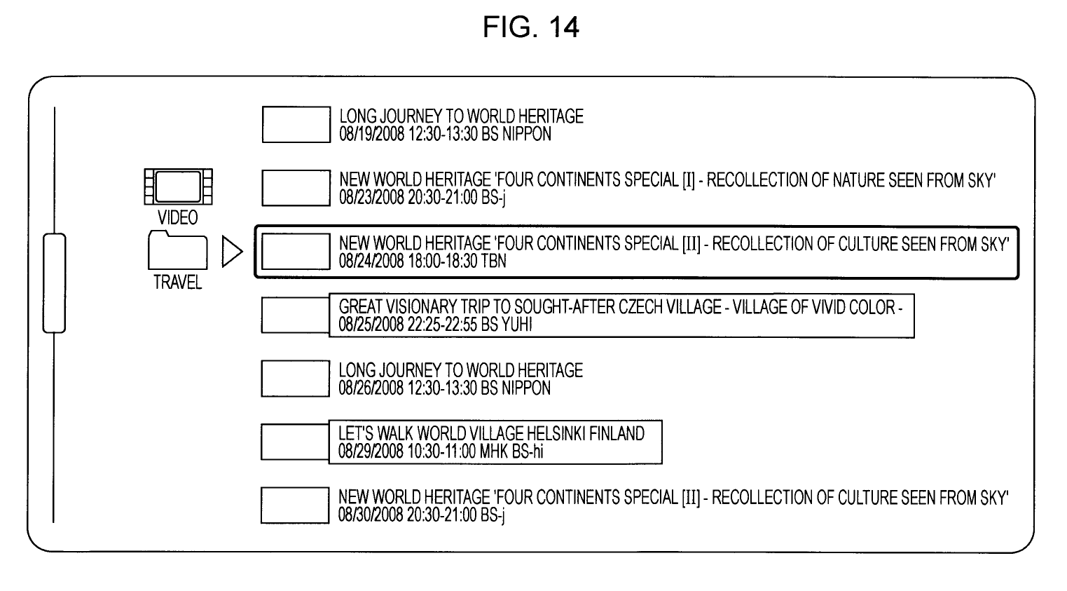

FIG. 14 is a diagram illustrating an exemplary display in which the program outline described in FIG. 4 is displayed so that the programs of which the total similarity ratio is smaller than a predetermined threshold value are not readily seen by a user. FIG. 14 shows that the program outline is displayed so that the background color of the program titles of the programs of which the total similarity ratio is smaller than the predetermined threshold value are displayed as a gray color. More specifically, in FIG. 14, the background color of the program title of a fourth program from the upper side and the background color of the program title of a sixth program from the upper side are displayed as the gray color. That is, the similarity degree between the noticed program and the fourth and sixth programs from the upper side is low.

The above-described example is not limited to the gray display of the background. The programs of which the total similarity ratio is smaller than the predetermined threshold value are not readily seen by a user by changing the character color of the program titles or displaying icons.

In this way, by displaying the programs of which the total similarity ratio is smaller than the predetermined threshold value so as not to be readily seen by a user, a deleting target program and a dubbing target program can be examined and selected carefully from the programs (which are not readily seen to the user) of the contents which are least likely to be the same as the contents of the programs selected by the user, when the user arranges the recorded programs while viewing the program outline. For example, only the programs which are least likely to have the same contents may be set to the dubbing target program and the other programs may be all set to the deleting target program.

In the above description, the program outline is displayed so that the programs of which the total similarity ratio is smaller than the predetermined threshold value are not readily seen by a user. However, the program outline may be emphasized for display so that the programs of which the total similarity ratio is larger than the predetermined threshold value are not readily seen by a user.

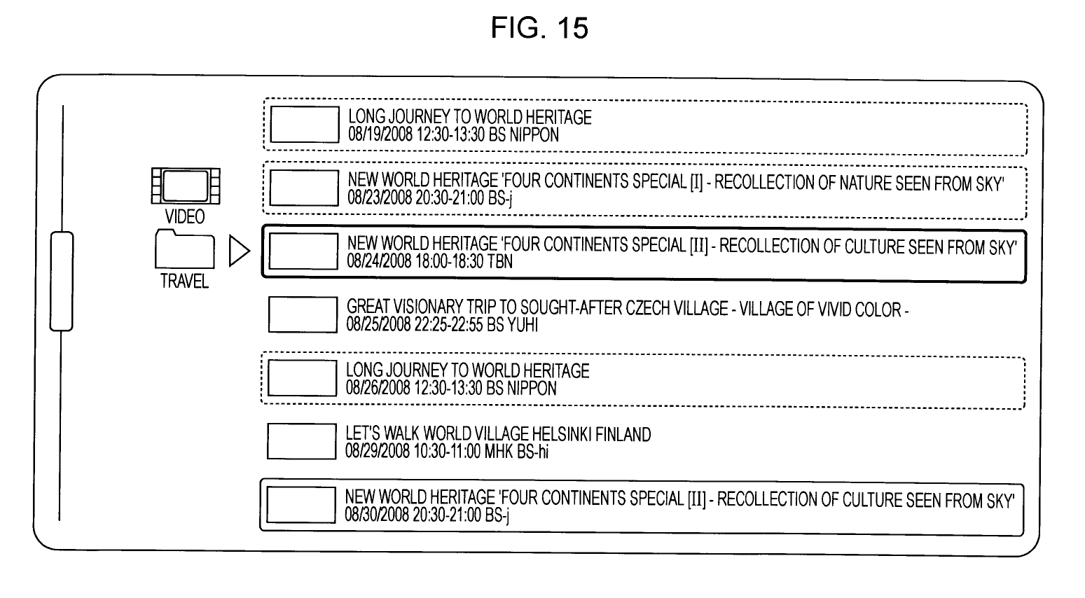

FIG. 15 is a diagram illustrating an exemplary display in which the program outline described in FIG. 4 is emphasized for display so that the programs of which the total similarity ratio is larger than a predetermined threshold value are not readily seen by a user. FIG. 15 shows that the program outline is displayed so that the program titles of the programs of which the total similarity ratio is larger than the predetermined threshold value are surrounded by a clear frame for emphasis. More specifically, the program titles of the uppermost program, a second program from the upper side, and a fifth program from the upper side in FIG. 15 are surrounded by a slight clear frame (indicated by a dashed line). The program title of the lowermost program is surrounded by a clearer frame (indicated by a solid line). That is, the uppermost program, the second program from the upper side, and the fifth program from the upper side have the high similarity degree with the noticed program. The lowermost program has the higher similarity degree with the noticed program.

The above-described example is not limited to the frame surrounding the program titles. The programs of which the total similarity ratio is larger than the predetermined threshold value may be emphasized for display by changing the character color or the background color of the program titles or displaying icons.

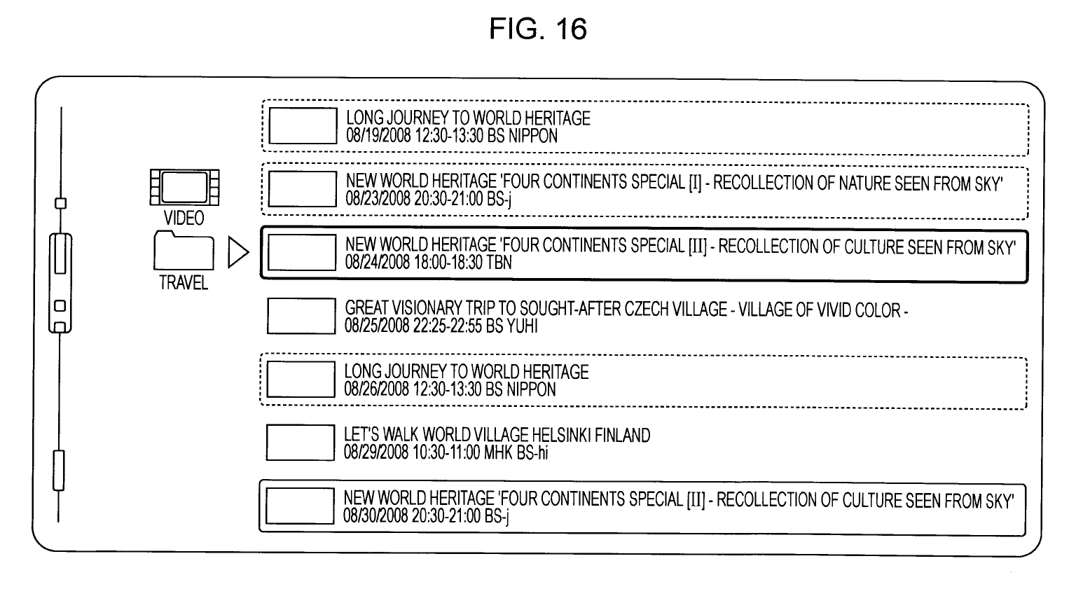

When there are programs (program titles) of which the total similarity ratio is larger than the predetermined threshold value above and below the seven programs of the program outlines shown in FIG. 15, a scroll bar may be emphasized for display depending on the positions of the programs, as in FIG. 16.

In FIG. 16, portions of the knob of the scroll bar corresponding to the positions of the programs, of which the total similarity ratio is larger than the predetermined threshold value in the currently displayed program outline, are emphasized with a predetermined color such as gray. In FIG. 16, portions of the rail of the scroll bar corresponding to the positions of the programs, of which the total similarity ratio is larger than the predetermined threshold value in the program outline which are not currently displayed, are emphasized with a predetermined color such as gray. More specifically, there is one program, of which the total similarity ratio is larger than the predetermined threshold value, on the upper side of seven programs shown in FIG. 16. In addition, on the lower side of the seven programs shown in FIG. 16, there are three programs, for example, of which the total similarity ratio is larger than the predetermined threshold value.

In this way, by emphasizing the programs of which the total similarity ratio is larger than the predetermined threshold value in the program outline, a deleting target program and a dubbing target program can be examined and selected carefully from the programs (which are emphasized for display) of the contents which are highly likely to be the same as the contents of the programs selected by the user, when the user arranges the recorded programs while viewing the program outline. For example, only the programs which are highly likely to have the same contents may be set to the dubbing target program and the other programs may be all set to the deleting target program.

In the above-described example, the programs of which the total similarity ratio is larger than the predetermined threshold value are emphasized and displayed in the program outline. However, only the programs of which the total similarity ratio is larger than the predetermined threshold value may be picked up for display.

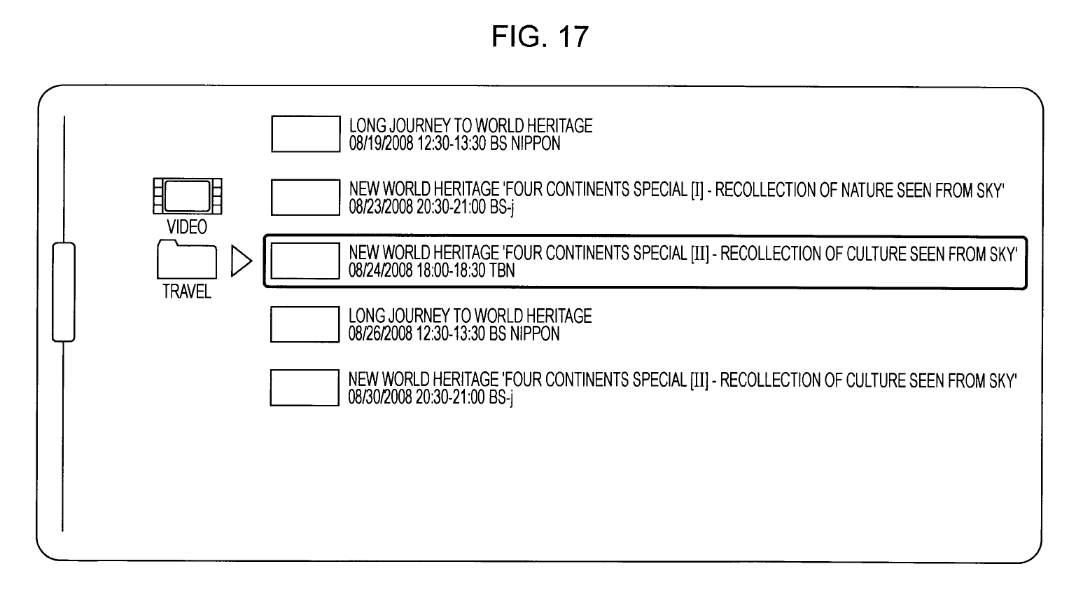

FIG. 17 is a diagram illustrating an exemplary display in which only the programs, of which the total similarity ratio is larger than the predetermined threshold value, are picked up for display in the program outline described in FIG. 4. More specifically, FIG. 17 shows program titles of the uppermost program, a second program from the upper side, a third program (noticed program) from the upper side, a fifth program from the upper side, and the lowermost program in the program outline in FIG. 4. That is, the uppermost program, the second program from the upper side, the fifth program from the upper side, and the lowermost program in the program outline in FIG. 4 have the high similarity degree with the noticed program. In FIG. 17, an icon displayed on the left side of the program title of the noticed program (the third program from the upper side) represents a folder in which the picked up program is recorded (stored). That is, in FIG. 17, the program displayed in the program outline is stored in the “pickup” folder of a “video” folder.

In the above-described example, a user may not select the programs other than the program picked up. Accordingly, the programs other than the program picked up may be selected in the program outline.

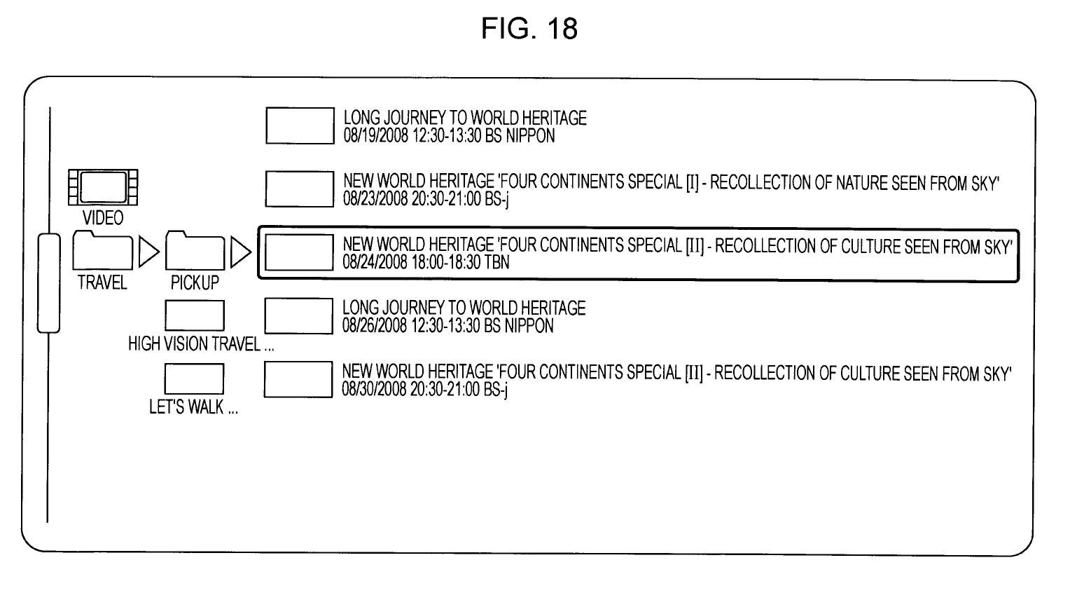

FIG. 18 is a diagram illustrating an exemplary program outline display in which the programs other than the program picked up may be selected in the program outline described with reference to FIG. 17. In FIG. 18, the program of which the total similarity ratio is not larger than the predetermined threshold value is displayed by an icon, after only the program, of which the total similarity ratio is larger than the predetermined threshold value, is picked up for display. More specifically, in FIG. 18, as in FIG. 17, program titles of the uppermost program, a second program from the upper side, a third program (noticed program) from the upper side, a fifth program from the upper side, and the lowermost program are displayed in the program outline in FIG. 4. In addition, icons representing a fourth program from the upper side and a sixth program from the upper side are displayed below a “pickup” folder. Program titles “Great Visionary Trip . . . ” and “Let's Walk . . . ” are respectively displayed below the icons representing the fourth program from the upper side and the sixth program from the upper side. Therefore, a user may select the programs other than the program picked up.

When there are also programs below and above the programs displayed in the program outline, as described in FIG. 1E, only the program, of which of which the total similarity ratio is larger than the predetermined threshold value, is picked up for display.

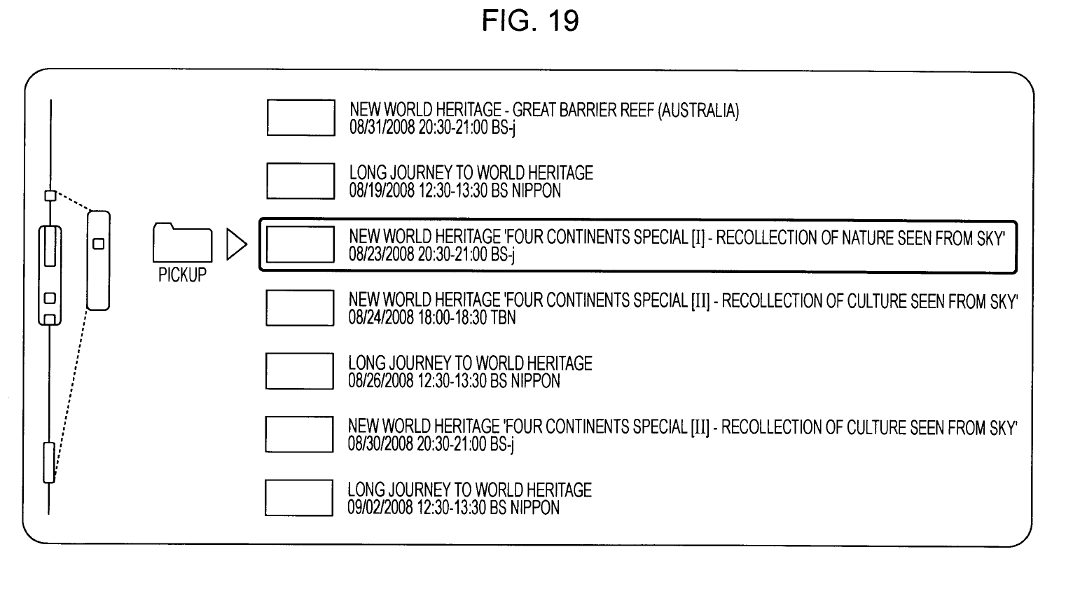

FIG. 19 is a diagram illustrating an exemplary display of a program outline in which only the program, of which the total similarity ratio is larger than the predetermined threshold value, is picked up for display, when there are also programs above and below the programs displayed in the program outline. In the program outline in FIG. 19, the program titles of the five programs shown in FIG. 17 are displayed as second to sixth programs from the upper side. In the program outline in FIG. 19, the uppermost program is a program which is present above the programs displayed in the program outline in FIG. 16 and of which the total similarity ratio is larger than the predetermined threshold value. In addition, the lowermost program is a program which is present below the programs displayed in the program outline in FIG. 16 and of which the total similarity ratio is larger than the predetermined threshold value. In the left end of FIG. 19, the same scroll bar as that in FIG. 16 is displayed in the same way as that of the case where the program, of which the total similarity ratio is larger than the predetermined threshold value, is not picked up. In the program outline in FIG. 19, a bar indicating the position (a black mark in the drawing) of the noticed program (which is a program selected by the operation of a user) among the programs picked up is displayed on the right side of the scroll bar.

In this way, by picking up and displaying only the programs of which the total similarity ratio is larger than the predetermined threshold value, a deleting target program and a dubbing target program can be examined and selected carefully from the programs (which are picked up for display) of the contents which are highly likely to be the same as the contents of the programs selected by the user, when the user arranges the recorded programs while viewing the program outline. For example, only the programs which are highly likely to have the same contents may be set to the dubbing target program and the other programs may be all set to the deleting target program.

In the above-described example, only the programs are displayed as the exemplary display of the display unit 61. However, the outline of a candidate program (dubbing candidate) to be dubbed (stored) in the removable media 45 from the HDD 43 by the operation of a user may be displayed together with the program outline.

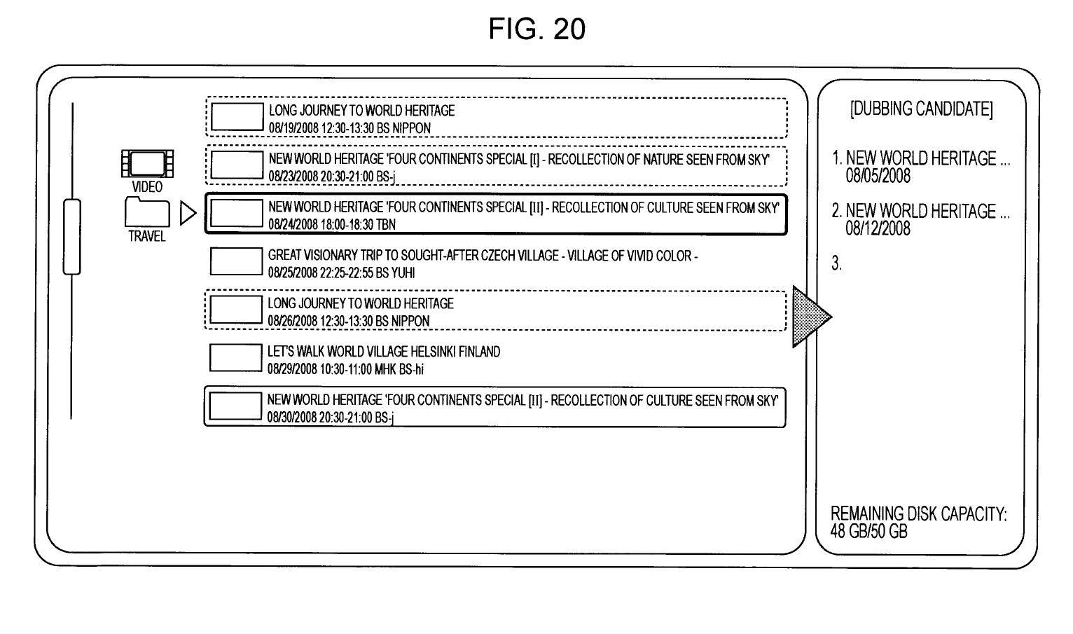

FIG. 20 is a diagram illustrating an exemplary display in which the outline of the dubbing candidate is displayed together with the program outline. As shown in FIG. 20, an area (dubbing candidate display area) where the outline of the dubbing candidate is displayed is displayed on the right side of the same program outline as the program outline described in FIG. 15. The program titles of two dubbing candidates selected in advance by the user are displayed in the dubbing candidate display area in FIG. 20. In the displayed state in FIG. 20, a predetermined program is selected in the program outline on the left side of FIG. 20 by operating an operation input unit (not shown) by the user and the program title is the dubbing candidate is newly added in the dubbing candidate display area. In the lower end of the dubbing candidate display area, the remaining disk capacity of the removable media 45, which is a dubbing destination, is displayed as “48 GB/50 GB” and an available capacity of the removable media 45 is displayed as 48 GB.

In this way, the dubbing candidate display area is displayed together with the program outline. Therefore, programs which are highly likely to be the same as the contents of the programs selected by the user, that is, programs which are considered not to be recorded (stored) in one recording medium, may be set to a deleting candidate program and the other programs may be all set to a dubbing target program, when the user arranges the recorded programs while viewing the program outline. Accordingly, the dubbing can be efficiently performed.

In the above-described example, “the program titles”, “the program summaries”, and “the program details”, which are the EPG data serving as the text data, of the noticed program and the comparison target program are separated into the words to compare the attributes of the words to each other. However, only the program titles” and “the program summaries” may be separated into words to compare the attributes of the words. Accordingly, since the process is not performed for “the program details”, the calculation amount can be reduced and the programs having the same contents can be more efficiently distinguished.

In the above description, the EPG data, which serve as the text data, of the noticed program and the comparison target program are separated into the words (analyzed into the morphemes) and the attributes (the parts of speech) of the words are compared to each other to calculate the similarity degree between the noticed program and the comparison target program. However, the similarity degree between the noticed program and the comparison target program may be calculated using another parameter included in the EPG data or an attribute obtained by processing (editing) the parameter, for example, a difference in “the broadcast times”.

### 2. Second Embodiment

Hereinafter, the similarity degree between the noticed program and the comparison target program calculated by using a difference in “the broadcast times” (play time length) included in the EPG data other than the correspondence series length will be described according to an embodiment. Since the hardware configuration of an HDD recorder according to this embodiment is the same as that in FIG. 1, the description is omitted.

### Exemplary Function Configuration of HDD Recorder

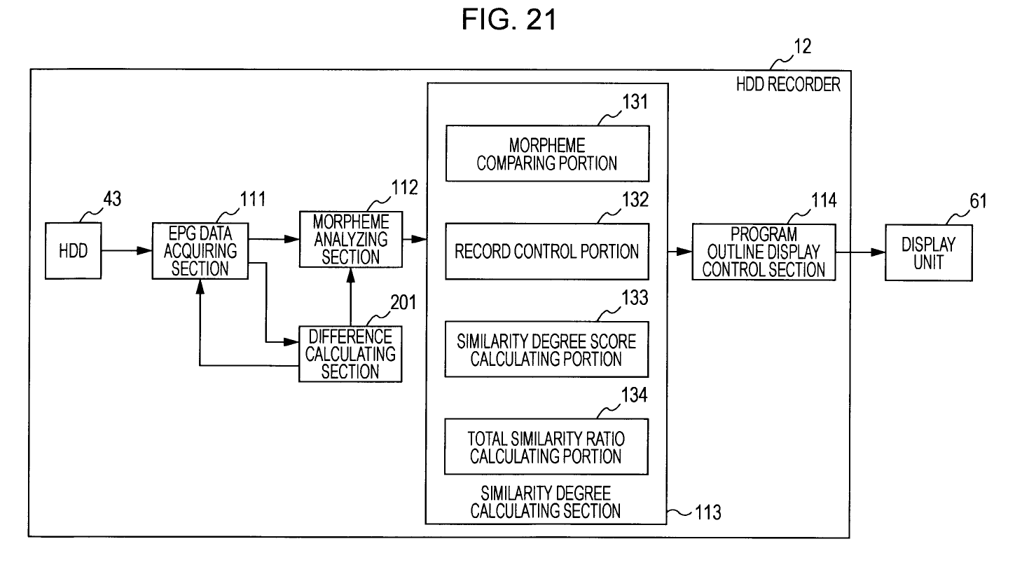

Next, the exemplary function configuration of a HDD recorder 12 according to this embodiment will be described with reference to FIG. 21. The same names and same reference numerals are given to the same functions of the HDD recorder 12 in FIG. 21 as those of the HDD recorder 12 in FIG. 2 and the description is appropriately omitted.

A difference calculating section 201 is newly provided as the different function of the HDD recorder 12 in FIG. 21 from the HDD recorder 12 in FIG. 2.

In the HDD recorder in FIG. 21, the EPG data acquiring section 111 acquires “the broadcast times” in addition to “the program titles” and “the program summaries” as the text data included in the EPG data of the programs recorded in the HDD 43.

The difference calculating section 201 calculates a difference between “the broadcast times” among the plural EPG data acquired by the EPG data acquiring section 111, compares the difference to a predetermined threshold value, and supplies the comparison result to the EPG data acquiring section 111 or the morpheme analyzing section 112.

### Process of Displaying Program Outline of HDD Recorder

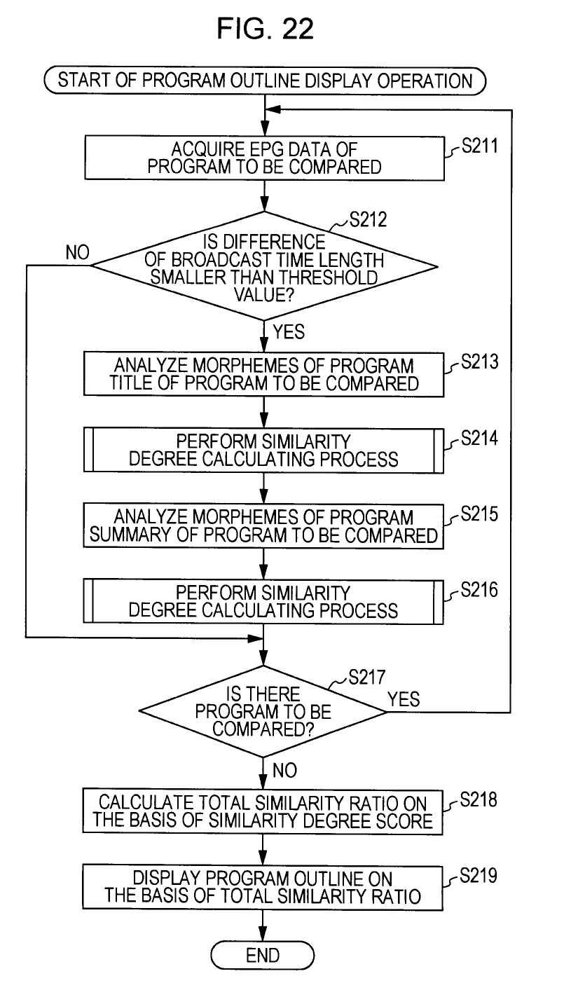

Hereinafter, a process of displaying the program outlines of the HDD recorder in FIG. 21 will be described with reference to the flowchart of FIG. 22. Since the processes of step S211 and steps S213 to S219 in the flowchart of FIG. 22 are the same as the processes from steps S11 to S15 and the processes from steps S18 to S20 described with reference to the flowchart of FIG. 3, the description is omitted.

That is, in step S212, the difference calculating section 201 calculates the difference between “the broadcast times” of the noticed program and the comparison target program among the plural EPG data acquired by the EPG data acquiring section 111 and determines whether the difference is smaller than the predetermined threshold value.

When it is determined in step S212 that the difference between “the broadcast times” of the noticed program and the comparison target program is smaller than the predetermined threshold value, the difference calculating section 201 supplies the morpheme analyzing section 112 with information indicating an instruction to analyze the morphemes of the EPG data, and then the process proceeds to step S213.

Alternatively, when it is determined in step S212 that the difference between “the broadcast times” of the noticed program and the comparison target program is not smaller than the predetermined threshold value, the difference calculating section 201 supplies the EPG data acquiring section 111 with information indicating an instruction to determine whether there are the EPG data of the program other than the comparison target program. Subsequently, the process skips steps S213 to S216 and proceeds to step S217.

In step S217, the total similarity ratio calculating portion 134 calculates the total similarity ratio on the basis of the score degree scores calculated for “the program titles” and “the program summaries” by the score degree score calculating portion 133.

In the above processes, since the comparison target program of the broadcast time of which the difference with the broadcast time of the noticed program is larger than a predetermined time is least likely to be the same program, the EPG data morpheme analyzing processor the similarity degree calculating process may not be performed. Accordingly, in the process of displaying the program outline, the calculation amount can be reduced and the programs having the same contents can be distinguished more efficiently and more exactly.

In the above description, in the EPG data morpheme analyzing processor, the similarity degree calculating process is performed after the difference between the broadcast times and the predetermined threshold value are compared to each other. However, information, which is acquired from the AV data (image data and voice data), on a time pattern of the program high degree, the main broadcast portion, a time length of a CM portion, and the like may be compared, and then the EPG data morpheme analyzing processor the similarity degree calculating process may be performed. Here, the time pattern of the program high degree refers to information based on a variation in the voice level of a program at every predetermined time, for example. Alternatively, information (metadata) regarding the programs to be compared may be acquired on the Internet, the information is compared, and then the EPG data morpheme analyzing processor the similarity degree calculating process may be performed. That is, the data other than the text data as data (EPG data) regarding the programs may be compared, a difference between the data may be detected, and then the EPG data morpheme analyzing processor the similarity degree calculating process may be performed.

The series of processes described above may be realized by hardware or may be realized by software. When the series of processes are realized by software, a program forming the software is installed from a program recording medium to a computer mounted in an exclusive-use hardware apparatus or a computer such as a general personal computer capable of executing various functions by installing various programs.

Examples of the program recording medium capable of storing the programs executable by a computer include a magnetic disk (including a flexible disk), an optical disk (including a CD-ROM (Compact Disk-Read Only Memory) and a DVD (Digital Disk-Read Only Memory)), a magneto-optical disk, the removable media 45, which is a package media formed of a semiconductor memory, and a hard disk forming the ROM 39 temporarily or permanently storing a program or the RAM 40, as shown in FIG. 1. The programs are stored in a program storing medium through the communication unit 41, which is an interface of a router, a modem, or the like or through a wired or wireless communication medium such as a network, a local area network, the Internet, or a digital satellite broadcast, as necessary.

The program executed by the computer may be a program executed in time series in accordance with the order described in the specification or a program executed in parallel or at necessary time in response to a call.

The present application contains subject matter related to that disclosed in Japanese Priority Patent Application JP 2009-035130 filed in the Japan Patent Office on Feb. 18, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
acquiring means for acquiring text data as data associated with plural contents;
separating means for separating the text data acquired by the acquiring means into words of a predetermined unit in accordance with attributes;
comparing means for calculating a correspondence length indicating the number of words which continuously correspond to each other in order of the attributes between the text data, by comparing the words, which are separated by the separating means, between the text data of the plural contents;
calculating means for calculating a similarity degree score indicating a similarity degree between the contents corresponding to the text data on the basis of the correspondence length obtained by the comparing means; and
display controlling means for controlling displaying outlines of the plural contents on the basis of the similarity degree score, which is calculated by the calculating means, between a predetermined content and another content among the plural contents.

2. The information processing apparatus according to claim 1, wherein the calculating means calculates the similarity degree score between the contents corresponding to the text data on the basis of the number of correspondence lengths depending on the sizes of the correspondence lengths and a weight corresponding to the correspondence lengths.

3. The information processing apparatus according to claim 2, wherein the weight has a larger value as the size of the correspondence length is larger.

4. The information processing apparatus according to claim 1,
wherein the separating means separates the text data into morphemes by analyzing the morphemes of the text data acquired by the acquiring means, and
wherein the comparing means obtains the correspondence length indicating the number of morphemes which continuously correspond to each other between the text data in order of parts of speech of the morphemes by comparing the morphemes between the text data of the plural contents, the morphemes being separated by the separating means.

5. The information processing apparatus according to claim 1, wherein on the basis of a magnitude relation between the similarity degree score between the predetermined content and the another content and a predetermined threshold value, the display controlling means controls the displaying of another content in the outlines of the plural contents.

6. The information processing apparatus according to claim 1, the display controlling means controls the display so as to emphasize the display of the another content, of which the similarity degree score with the predetermined content is larger than the predetermined threshold value, in the outlines of the plural contents.

7. The information processing apparatus according to claim 1, wherein the display controlling means controls the display so that the another content, of which the similarity degree score with the predetermined content is larger than the predetermined threshold value, is displayed in the outlines of the plural contents.

8. The information processing apparatus according to claim 1, further comprising:
difference detecting means for detecting a difference between data, which are respectively associated with the predetermined content and the another content among the plural contents, other than the text data,
wherein the separating means separates the text data of the predetermined content and the another content, of which the difference detected by the difference detecting means is smaller than a predetermined degree, into the words of the predetermined unit.

9. An information processing method comprising the steps of:
acquiring text data as data associated with plural contents;
separating the text data acquired by the acquiring step into words of a predetermined unit in accordance with attributes;
calculating a correspondence length indicating the number of words which continuously correspond to each other in order of the attributes between the text data, by comparing the words, which are separated by the separating means, between the text data of the plural contents;
calculating a similarity degree score indicating a similarity degree between the contents corresponding to the text data on the basis of the correspondence length obtained by the comparing step; and
controlling displaying outlines of the plural contents on the basis of the similarity degree score, which is calculated by the calculating step, between a predetermined content and another content among the plural contents.

10. A program causing a computer to execute:
an acquiring step of acquiring text data as data associated with plural contents;
a separating step of separating the text data acquired by the acquiring step into words of a predetermined unit in accordance with attributes;
a comparing step of calculating a correspondence length indicating the number of words which continuously correspond to each other in order of the attributes between the text data, by comparing the words, which are separated by the separating means, between the text data of the plural contents;
a calculating step of calculating a similarity degree score indicating a similarity degree between the contents corresponding to the text data on the basis of the correspondence length obtained by the comparing step; and
a display controlling step of controlling displaying outlines of the plural contents on the basis of the similarity degree score, which is calculated by the calculating step, between a predetermined content and another content among the plural contents.

11. An information processing apparatus comprising:
an acquiring unit acquiring text data as data associated with plural contents;
a separating unit separating the text data acquired by the acquiring unit into words of a predetermined unit in accordance with attributes;
a comparing unit calculating a correspondence length indicating the number of words which continuously correspond to each other in order of the attributes between the text data, by comparing the words, which are separated by the separating unit, between the text data of the plural contents;
a calculating unit calculating a similarity degree score indicating a similarity degree between the contents corresponding to the text data on the basis of the correspondence length obtained by the comparing unit; and
a display controlling unit controlling displaying outlines of the plural contents on the basis of the similarity degree score, which is calculated by the calculating unit, between a predetermined content and another content among the plural contents.
